(19) United States
(12) Patent Application Publication
(10) Pub. No.: US 2025/0199765 A1
(43) Pub. Date: Jun. 19, 2025

(54) SYSTEMS AND METHODS FOR PERFORMING MAC OPERATIONS WITH REDUCED COMPUTATION RESOURCES

(71) Applicant: Taiwan Semiconductor Manufacturing Company, Ltd., Hsinchu (TW)

(72) Inventor: Hiroaki Ishii, Hsinchu (TW)

(73) Assignee: Taiwan Semiconductor Manufacturing Company, Ltd., Hsinchu (TW)

(21) Appl. No.: 18/626,069

(22) Filed: Apr. 3, 2024

Related U.S. Application Data
(60) Provisional application No. 63/609,657, filed on Dec. 13, 2023.

(51) Int. Cl. G06F 7/523; G06F 7/02; G06F 7/50

(52) U.S. Cl. CPC G06F 7/523; G06F 7/02; G06F 7/50

(57) ABSTRACT

A computing-in-memory (CIM) circuit includes an input circuit to receive N first inputs and N second inputs; N summing circuits, each configured to combine the first exponent and the second exponent of one of the N input pairs to generate one of N exponent sums; a selector circuit to select a largest exponent sum; N subtractor circuits, each configured to calculate one of N exponent differences, each equal to a difference between one of the N exponent sums and the largest exponent sum; N comparator circuits, each configured to: compare the exponent difference with an exponent sum threshold, and generate one of N control signals based on the comparison; and N multiplier circuits, each configured to selectively multiply the corresponding first mantissa by the corresponding second mantissa of the corresponding input pair based on the respective control signal, so as to generate a corresponding one of N mantissa products.

### CROSS-REFERENCE TO RELATED APPLICATION

This application claims priority to and the benefit of U.S. Provisional Application No. 63/609,657, filed Dec. 13, 2023, entitled “METHOD AND APPARATUS OF REDUCING COMPUTATION RESOURCE OF MAC (MULTIPLY AND ACCUMULATE) OPERATION,” which is incorporated herein by reference in its entirety for all purposes.

### BACKGROUND

Computer artificial intelligence (AI) has been built on machine learning, for example, using deep learning techniques. With machine learning, a computing system organized as a neural network computes a statistical likelihood of a match of input data with prior computed data. A neural network refers to a number of interconnected processing nodes that enable the analysis of data to compare an input to “trained” data. Trained data refers to computational analysis of properties of known data to develop models to use to compare input data. An example of an application of AI and data training is found in object recognition, where a system analyzes the properties of many (e.g., thousands or more) of images to determine patterns that can be used to perform statistical analysis to identify an input object.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a data computation circuit for performing MAC operations on floating point numbers with reduced computation resources, in accordance with some embodiments.

FIG. 2 is a block diagram of a portion of the data computation circuit of FIG. 1 for masking an input mantissa, in accordance with some embodiments.

FIG. 3 is a timing diagram of the data computation circuit of FIG. 1 performing the MAC operations on the floating point numbers, in accordance with some embodiments.

FIG. 4 is a block diagram of a portion of the data computation circuit of FIG. 1 for masking a weight mantissa, in accordance with some embodiments.

FIG. 5 is a block diagram of a portion of the data computation circuit of FIG. 1 for masking a multiplier output, in accordance with some embodiments.

FIG. 6 is a block diagram of a portion of the data computation circuit of FIG. 1 for directly outputting a result of the multiplier, in accordance with some embodiments.

FIG. 7 is a block diagram of a portion of the data computation circuit of FIG. 1 for masking the weight mantissa including a similarity circuit for weight exponents, in accordance with some embodiments.

FIG. 8 is a block diagram of the similarity circuit of FIG. 7 to determine whether the exponents are the same, in accordance with some embodiments.

FIG. 9 is a block diagram of a portion of the data computation circuit of FIG. 1 for masking the weight mantissa including a similarity circuit for input exponents, in accordance with some embodiments.

FIG. 10 illustrates a flow chart of an example method of performing MAC operations on floating point numbers with reduced computation resources, in accordance with various embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Neural networks compute “weights” to perform computation on new data (an input data “word”). Neural networks use multiple layers of computational nodes, where deeper layers perform computations based on results of computations performed by higher layers. Machine learning currently relies on the computation of dot-products and absolute difference of vectors, typically computed with multiply-accumulate (MAC) operations performed on the parameters, input data and weights. The computation of large and deep neural networks typically involves so many data elements, and thus it is not practical to store them in processor cache. Accordingly, these data elements are usually stored in a memory.

Thus, machine learning is very computationally intensive with the computation and comparison of many different data elements. The computation of operations within a processor is orders of magnitude faster than the transfer of data elements between the processor and main memory resources. Placing all the data elements closer to the processor in caches is prohibitively expensive for the great majority of practical systems due to the memory sizes needed to store the data elements. Thus, the transfer of data elements becomes a major bottleneck for AI computations. As the data sets increase, the time and power/energy a computing system uses for moving data elements around can end up being multiples of the time and power used to actually perform computations.

In this regard, computing-in-memory (CIM) circuits have been proposed to perform such MAC operations. Similar to a human brain, a CIM circuit instead conducts data processing in situ within a suitable memory circuit. The CIM circuit suppresses the latency for data/program fetch and output results upload in corresponding memory (e.g. a memory array), thus solving the memory (or von Neumann) bottleneck of conventional computers. Another key advantage of the CIM circuit is the high computing parallelism, thanks to the specific architecture of the memory array, where computation can take place along several current paths at the same time. The CIM circuit also benefits from the high density of multiple memory arrays with computational devices, which generally feature excellent scalability and the capability of 3D integration. As a non-limiting example, the CIM circuit targeted for various machine learning applications can perform the MAC operations locally within the memory (i.e., without having to send data elements to a host processor) to enable higher throughput dot-product of neuron activation and weight matrices, while still providing higher performance and lower energy compared to computation by the host processor.

The data elements, processed by the CIM circuit, have various types or forms, such as integers number and floating point numbers. A floating point number is typically represented by a sign portion, an exponent portion, and a significand (mantissa) portion that consists of the significant digits of the number. For example, a floating point number format specified by the Institute of Electrical and Electronics Engineers (IEEE®) is thirty-two bits in size and includes twenty-three mantissa bits, eight exponent bits, and one sign bit. Another floating point number format is sixteen bits in size, which includes ten mantissa bits, five exponent bits, and one sign bit.

In machine learning applications, the CIM circuit is frequently configured to process dot product multiplications based on performing MAC operations on a large number of data elements (e.g., an input word vector and a weight matrix), which may each be in the form of floating point numbers, and then process addition (or accumulation) of such dot products. Multiplication of each floating point number pair, generally, includes addition of respective exponent portions (generating an exponent sum) and multiplication of respective mantissa portions (generating a mantissa product). Further, the exponent sum of each floating point number pair is compared to a maximum exponent sum among the plural floating point number pairs to generate an exponent difference. Such exponent differences are utilized to align the exponent portions of the different floating point number pairs, so as to shift the corresponding mantissa products. The shifted mantissa products are summed, with an exponent of the maximum exponent sum, to reach the final sum.

With such an approach, the multiplication of floating point numbers (in MAC operation) may be performed regardless of the differences in the sizes of the input values (e.g., floating point numbers). In other words, certain circuits may perform calculations even if at least one relatively small value/number (e.g., floating point number with relatively small exponent numbers) exists in the multiplication process of the MAC operation. These calculations may be performed without considering the sizes (or exponent numbers) of the input values. However, in the case of the floating point MAC operation, certain pairs of input values may be sufficiently small compared to other pairs of inputs (e.g., relatively small exponent value compared to the maximum or highest exponent values of the various pairs of input values) that such pairs of input values may be ignored. In such scenarios, during the accumulation process, the addition of a minute value (e.g., input pair with relatively small exponent value) to other values (e.g., input pair with relatively high exponent value) may have a negligible impact on the overall magnitude of the other values. As such, performing the multiplication using the original input values (e.g., the mantissa portion of the input data and the weight data) can be a waste of the computation resources because of the negligible impact on the result of the MAC operation, e.g., the result of the accumulation process.

For example, a certain circuit can perform a MAC operation for floating point numbers, including pairs of input values (e.g., including input data and weight data) for multiplication and accumulation. The input data and weight data can include the respective mantissa portion and exponent portion, where the size of the input data or the weight data can be based on the exponent portion. If at least one of the input data or the weight data is relatively small compared to other input values, the result of the multiplication process of the respective pair of input values can be sufficiently small (e.g., a value of around zero compared to the result of other multiplication pairs) to not impact the accumulation process of MAC operation. Thus, computing the various floating point numbers regardless of their sizes can lead to an increase or excessive consumption of computation resources, increase the number of clock cycles to perform the MAC operation, and/or reduce computing efficiency.

The present disclosure provides various embodiments of a compute-in-memory (CIM) circuit that can determine whether to apply a mask during the multiplication process. The disclosed CIM circuit can include a feature or a component for detecting whether the input values are small, thereby taking preventive measures for the multipliers to reduce computation/calculation resource/power usage for the MAC operation. In one aspect, the disclosed CIM circuit can mask at least one of the input of the multiplier or the output of the multiplier according to the difference in the exponents of each pair of input values and the maximum exponent. Masking the input or the output can include changing at least one of the input values to zero or applying zero to the multiplication output according to the exponent difference. Given the zero product property (e.g., multiplying zero by any number results in zero), the multiplication computation can be minimized. In another aspect, the disclosed CIM circuit can directly output a predetermined value (e.g., zero) according to the exponent difference of each pair of input values. By applying the (zero) mask or directly outputting zero as the result of multiplying the input value pair having a relatively small exponent, the computation resources can be reduced, energy efficiency can be enhanced, and the computation latency can be minimized when performing the MAC operation for floating point numbers.

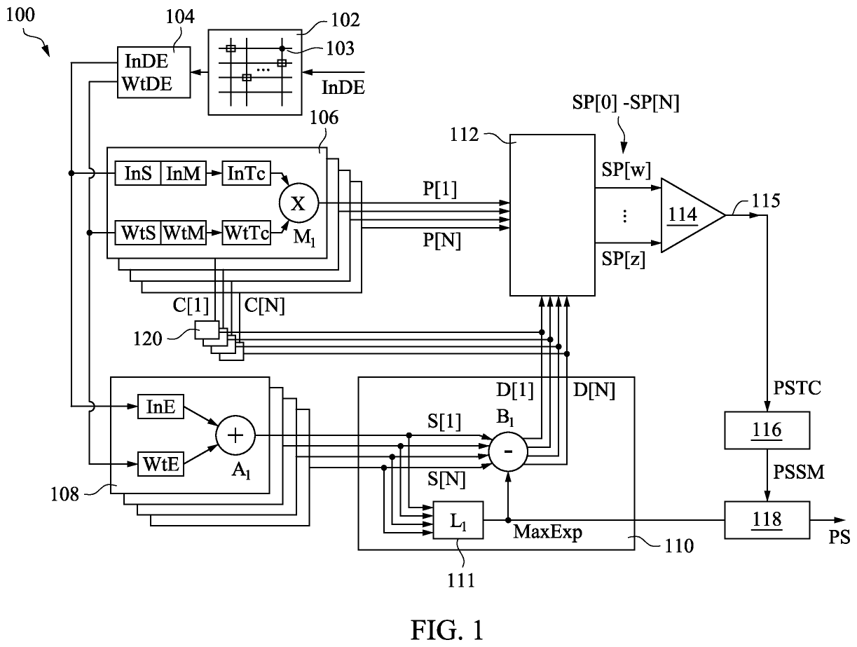

FIG. 1 illustrates a block diagram of a data computation circuit 100, in accordance with some embodiments of the present disclosure. In the illustrated embodiment depicted in FIG. 1, the data computation circuit 100, also referred to as (e.g., CIM) circuit 100 or memory circuit 100, includes various components collectively configured to perform in-memory computations (e.g., multiply-accumulate (MAC) operations) on an input word vector and a weight matrix. The input word vector can include a plural number (N) of input data elements InDE, and the weight matrix can include a plural number (Nd) of weight data elements WtDE. In various embodiments, each of the input data elements InDE and the weight data elements WtDE may include a floating point number.

As shown, the circuit 100 includes a memory circuit 102, an input circuit 104, a number of multiplier circuits 106, a number of summing circuits 108, a difference circuit 110 (e.g., sometimes referred to as a subtractor circuit 110), a shifting circuit 112, an adder circuit (or adder tree) 114, a first converter 116, a second converter 118, and a comparator circuit 120 (e.g., sometimes referred to as a masking circuit 120). In some embodiments, the number of multiplier circuits 106 may correspond to the number of summing circuits 108 or the number of comparator circuit 120. For example, the circuit 100 may include N (the number of weight/input data elements WtDE/InDE) multiplier circuits 106, N (the number of weight/input data elements WtDE/InDE) summing circuits 108, and N (the number of weight/input data elements WtDE/InDE) comparator circuit 120. It should be appreciated that the block diagram of the circuit depicted in FIG. 1 is simplified, and thus, the circuit 100 can include any of various other components while remaining within the scope of the present disclosure.

The memory circuit 102 may include one or more memory arrays and one or more corresponding circuits. The memory arrays are each a storage device including a number of storage elements 103, each of the storage elements 103 including an electrical, electromechanical, electromagnetic, or other device configured to store one or more data elements, each data element including one or more data bits represented by logical states. In some embodiments, a logical state corresponds to a voltage level of an electrical charge stored in a portion or all of a storage element 103. In some embodiments, a logical state corresponds to a physical property, e.g., a resistance or magnetic orientation, of a portion or all of a storage element 103.

In some embodiments, the storage element 103 includes one or more static random-access memory (SRAM) cells. In various embodiments, an SRAM cell includes a number of transistors, e.g., a five-transistor (5T) SRAM cell, a six-transistor (6T) SRAM cell, an eight-transistor (8T) SRAM cell, a nine-transistor (9T) SRAM cell, etc. In some embodiments, an SRAM cell includes a multi-track SRAM cell. In some embodiments, an SRAM cell includes a length at least two times greater than a width.

In some embodiments, the storage element 103 includes one or more dynamic random-access memory (DRAM) cells, resistive random-access memory (RRAM) cells, magnetoresistive random-access memory (MRAM) cells, ferroelectric random-access memory (FeRAM) cells, NOR flash cells, NAND flash cells, conductive-bridging random-access memory (CBRAM) cells, data registers, non-volatile memory (NVM) cells, 3D NVM cells, or other memory cell types capable of storing bit data.

In addition to the memory array(s), the memory circuit 102 can include a number of circuits to access or otherwise control the memory arrays. For example, the memory circuit 102 may include a number of (e.g., word line) drivers operatively coupled to the memory arrays. The drivers can apply signals (e.g., voltages) to the corresponding storage elements 103 so as to allow those storage elements 103 to be accessed (e.g., programmed, read, etc.). For another example, the memory circuit 102 may include a number of programming circuits and/or read circuits that are operatively coupled to the memory arrays.

The memory arrays of the memory circuit 102 are each configured to store a number of the weight data elements WtDE. In some embodiments, the programming circuits may write the weight data elements WtDE into corresponding storage elements 103 of the memory arrays, respectively, while the reading circuit may read bits written into the storage elements 103, so as to verify or otherwise test whether the written weight data elements WtDE are correct. The drivers of the memory circuit 102 can include or be operatively coupled to a number of input activation latches that are configured to receive and temporarily store the input data elements InDE. In some other embodiments, such input activation latches may be part of the input circuit 104, which can further include a number of buffers that are configured to temporarily store the weight data elements WtDE retrieved from the memory arrays of the memory circuit 102. As such, the input circuit 104 can receive the input data elements InDE and the weight data elements WtDE.

In various embodiments of the present disclosure, the input word vector (including, e.g., the input data elements InDE) and the weight matrix (including, e.g., the weight data elements WtDE), on which the circuit 100 is configured to perform MAC operations, each include a number of floating point numbers. As such, each of the data elements InDE and weight data elements WtDE includes a sign bit, a plural number of exponent bits, and a plural number of mantissa bits (sometimes referred to as fraction bits).

For example, each of the data elements InDE and weight data elements WtDE has a BF16 format, also referred to as a bfloat format or brain floating-point format in some embodiments, in which a first bit represents a sign of a floating-point number, a subsequent eight bits represent an exponent of the floating-point number, and the final seven bits represent the mantissa, or fraction, of the floating-point number. Because the mantissa is configured to start with a non-zero value, the final seven bits of each stored data element represent an eight-bit mantissa having a first, most significant bit (MSB) equal to one.

In some embodiments, each of the data elements InDE and the weight data elements WtDE has a FP16 format, also referred to as a half precision format, in which a first bit represents a sign of a floating-point number, a subsequent five bits represent an exponent of the floating-point number, and the final ten bits represent the mantissa, or fraction, of the floating-point number. In this case, the final ten bits of each stored data element represent an eleven-bit mantissa having a first MSB equal to one. In some other embodiments, each of the data elements InDE and the weight data elements WtDE has a floating-point format other than a BF16 or FP16 format, e.g., another 16-bit format, a 32-bit, 64-bit, 128-bit, or 256-bit format, or a 40-bit or 80-bit extended precision format. The sign and mantissa of a data element representing a floating-point number are collectively referred to as a signed mantissa of the floating-point number. The MSB of a mantissa is referred to as a hidden bit or hidden MSB.

Referring still to FIG. 1, the input circuit 104 is configured to output entireties of each data element of data elements InDE and WtDE to each of the multiplier circuits 106 and the summing circuits 108. In some embodiments, the input circuit 104 is configured to output the signed mantissa of each data element to the multiplier circuit 106 and the exponent of each data element to the summing circuit 108, which will be described as follows.

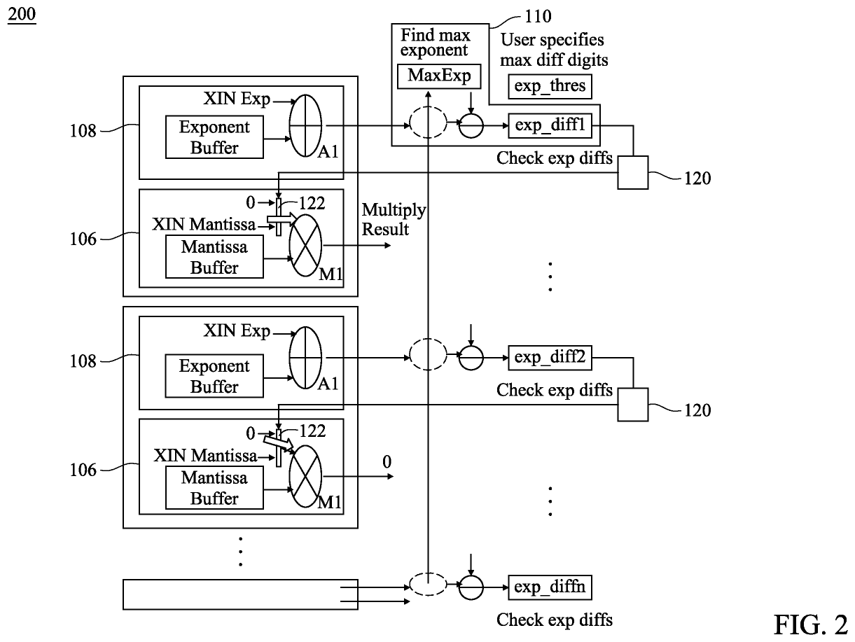

The multiplier circuits 106 are each an electronic circuit, e.g., an integrated circuit (IC), configured to receive, e.g., from the input circuit 104, a sign bit InS and a mantissa InM (collectively a signed mantissa InS/InM) of each of the N data elements InDE, and a sign bit WtS and a mantissa WtM (collectively a signed mantissa WtS/WtM) of each of the N data elements WtDE. Each of the multiplier circuits 106 can further receive a signal (e.g., control signal) from a corresponding one of the comparator circuits 120 to determine whether to mask at least one of the mantissa InM, the mantissa WtM, the multiplier output, or the corresponding product from the multiplier circuit 106, such as described in conjunction with but not limited to at least one of FIGS. 2-10. The summing circuits 108 are each an electronic circuit, e.g., an IC, configured to receive, e.g., from the input circuit 104, an exponent InE of each of the N data elements InDE, and an exponent WtE of each of the N data elements WtDE.

The multiplier circuits 106 may each include one or more data registers (not shown) configured to receive the instances of signed mantissas InS/InM and WtS/WtM. In the embodiment depicted in FIG. 1, the multiplier circuit 106 is configured to receive the instances of signed mantissas InS/InM and WtS/WtM corresponding to data elements InDE and WtDE. In some other embodiments, the multiplier circuit 106 includes the one or more data registers configured to receive the instances of signed mantissas InS/InM and/or WtS/WtM including the hidden MSBs. In some embodiments, the multiplier circuit 106 includes the one or more data registers configured to add the hidden MSBs to the received instances of signed mantissas InS/InM and/or WtS/WtM.

The multiplier circuit 106 may include logic circuitry (not shown) configured to, in operation, reformat each instance of signed mantissa InS/InM to a two's complement mantissa InTC, also referred to as reformatted mantissa InTC, and to reformat each instance of signed mantissa WtS/WtM to a two's complement mantissa WtTC, also referred to as reformatted mantissa WtTC. Reformatted mantissa InTC has a same number of bits as signed mantissa InS/InM, and reformatted mantissa WtTC has a same number of bits as signed mantissa WtS/WtM.

The multiplier circuit 106 may include one or more logic gates M1 configured to, in operation, multiply some or all of the instances of reformatted mantissas InTC with some or all of the instances of reformatted mantissas WtTC, thereby generating N products, e.g., P[1] to P[N]. In various embodiments, the one or more logic gates M1 include one or more AND or NOR gates or other circuits suitable for performing some or all of a multiplication operation. The one or more logic gates M1 are configured to, in operation, generate each of the products P[1] to P[N] as a two's complement data element including a number of bits equal to twice the number of bits of reformatted mantissas InTC and WtTC minus one. The one or more logic gates M1 may be referred to as a multiplier configured to multiply some or all of the instances of reformatted mantissas InTC with some or all of the instances of reformatted mantissas WtTC. In some cases, the multiplier (e.g., the one or more logic gates M1) can receive the signed mantissa InS/InM or the signed mantissa WtS/WtM for the multiplication.

The multiplier circuits 106 are configured to, in operation, generate the number N of products P[1] to P[N]. For example, the multiplier circuits 106 can generate the number N of products P[1]-P[N] equal to sixteen. In some other embodiments, the multiplier circuits 106 can generate the number N of products P[1]-P[N] fewer or greater than sixteen.

In some embodiments, e.g., those in which data elements InDE and WtDE have the BF16 format, the multiplier circuit 106 is configured to generate each of the products P[1]-P[N] having a total of 17 bits based on each of signed mantissas InS/InM and WtS/WtM and reformatted mantissas InTC and WtTC having a total of nine bits. In some embodiments, e.g., those in which data elements InDE and WtDE have the FP16 format, the multiplier circuit 106 is configured to generate each of products P[1]-P[N] having a total of 23 bits based on each of signed mantissas InS/InM and WtS/WtM and reformatted mantissas InTC and WtTC having a total of 12 bits. Embodiments in which the multiplier circuit 106 is configured to generate each of products P[1]-P[N] having other total bit numbers based on each of signed mantissas InS/InM and WtS/WtM and reformatted mantissas InTC and WtTC having other total bit numbers are within the scope of the present disclosure.

The multiplier circuit 106 is thereby configured to, in operation, perform multiplication and reformatting operations on sign and mantissa bits of input data elements InDE and weight data elements WtDE so as to generate two's complement products P[1]-P[N]. The multiplier circuit 106 is configured to output products P[1]-P[N] to the shifting circuit 112 on a data bus (not shown).

In various implementations, the multiplier circuit 106 can include one or more other components to perform the multiplication (or simplify the multiplication process). For example, the multiplier circuit 106 can include one or more multiplexers (MUX), switches, or other types of logic components configured to mask at least one of the input or the output of the one or more logic gates M1, such as MUX 122, as described in conjunction with at least one of but not limited to FIGS. 2, 4-7, and 9. The multiplier circuit 106 may include other types of logic components configured to perform similar functions as the MUX 122, e.g., for selecting one of multiple inputs to provide as an output based on the control signal. As described in conjunction with at least one of FIGS. 2, 4-7, and 9, the MUX 122 can include a plurality of input ports, such as a first input port, a second input port, and a control port. The first input port can receive a predefined value (e.g., zero, sometimes referred to as a masking value) as a first input to the MUX 122. The second input port can receive a value from one of the input circuit 104 (e.g., the mantissa InM or WtM or reformatted mantissa InTc or WtTc) or a value from the one or more logic gates M1 (e.g., the corresponding product P[n]) as a second input to the MUX 122. The second input may be referred to as an original value, corresponding to the value from the input circuit 104 or the one or more logic gates M1. The first input and the second input may be interchangeable. The control port of the MUX 122 can receive a control signal (e.g., 0 or 1) from the corresponding comparator circuit 120 in communication with the multiplier circuit 106. Depending on the control signal, the MUX 122 can output either zero or the original value.

In another example, the one or more logic gates M1 of the multiplier circuit 106 can be configured to receive a third input, in addition to the corresponding reformatted mantissa InTc and the reformatted mantissa WtTC. The third input can include or correspond to the control signal from the corresponding comparator circuit 120, including a value of 0 or 1. The one or more logic gates M1 can multiply the reformatted mantissas InTc and the reformatted mantissas WtTC by the control signal. In such cases, depending on the control signal, the one or more logic gates M1 can either output 0 (e.g., the control signal=0) as the product P[n] or output the product of the reformatted mantissa InTc and the reformatted mantissa WtTC (e.g., the control signal=1). By masking the input or the output of the one or more logic gates M1 with 0 or multiplying the inputs of the one or more logic gates M1 by 0, the circuit 100 can ignore relatively small values (e.g., values with relatively small exponent value), thereby minimizing resource consumption for performing MAC operation with floating point numbers.

The summing circuits 108 each include one or more data registers (not shown) configured to receive the instances of exponents InE and WtE corresponding to the number of data elements of data elements InDE and WtDE discussed above with respect to the multiplier circuit 106.

The summing circuits 108 each include one or more logic gates A1 configured to, in operation, add each instance of exponent InE to each instance of exponent WtE. In various embodiments, the one or more logic gates A1 include one or more full adder gates, half adder gates, ripple-carry adder circuits, carry-save adder circuits, carry-select adder circuits, carry-look-ahead adder circuits, or other circuits suitable for performing some or all of an addition operation. The respective logic gates A1 of the summing circuits 108 are configured to generate exponent sums S[1]-S[N] as data elements having a total number of bits equal to the number of bits of each of exponents InE and WtE plus one.

The summing circuits 108 are configured to, in operation, generate the exponent sums S[1]-S[N] having the total number N and an ordering of data elements corresponding to the total number N and ordering of the data elements of the products P[1]-P[N] discussed above with respect to the multiplier circuit 106. Accordingly, for a total of N combinations of data elements InDE and WtDE, each n^{th} combination corresponds to both the n^{th} exponent sum S[n] of the exponent sums S[1]-S[N] and the n^{th} product P[n] of the products P[1]-P[N].

In some embodiments, e.g., those in which the data elements InDE and WtDE have the BF16 format, the summing circuit 108 is configured to generate each corresponding one of the exponent sums S[1]-S[N] having a total of nine bits based on each of the exponents InE and WtE having a total of eight bits. In some embodiments, e.g., those in which the data elements InDE and WtDE have the FP16 format, the summing circuit 108 is configured to generate each of the sums S[0]-S[N] having a total of six bits based on each of exponents InE and WtE having a total of five bits. The summing circuit 108 being configured to generate each of the exponent sums S[1]-S[N] having other total bit numbers based on each of exponents InE and WtE having other total bit numbers is within the scope of the present disclosure. The summing circuits 108 are configured to output the exponent sums S[1]-S[N] to the difference circuit 110 on a data bus (not shown).

The difference circuit 110 is an electronic circuit, e.g., an IC, including one or more logic gates L1 (e.g., corresponding to or as a part of a selector circuit 111) and one or more logic gates B1, each configured to receive the exponent sums S[1]-S[N] from the summing circuits 108. The one or more logic gates L1 may sometimes referred to as a selector, and the one or more logic gates B1 may sometimes be referred to as a subtractor. The one or more logic gates L1 are configured to, in operation, generate a maximum exponent sum MaxExp as a data element having a value equal to a maximum value of the data elements of the exponent sums S[1]-S[N] and having a number of bits equal to those of the data elements of the exponent sums S[1]-S[N]. The one or more logic gates L1 are configured to output maximum exponent sum MaxExp to the one or more logic gates B1 and to the converter circuit 124, as discussed below.

The one or more logic gates B1 are configured to, in operation, generate differences D[1]-D[N] by subtracting each data element of the exponent sums S[1]-S[N] from maximum exponent sum MaxExp. The differences D[1]-D[N] thereby have the total number N and ordering of data elements corresponding to that of the exponent sums S[1]-S[N] and the products P[1]-P[N] discussed above. In the embodiment depicted in FIG. 1, the one or more logic gates B1 are configured to output differences D[1]-D[N] to the shifting circuit 112 and the comparator circuit 120 on one or more data buses (not shown). In some embodiments, the one or more logic gates B1 are not configured to output the differences D[1]-D[N] to the multiplier circuits 106, and the multiplier circuits 106 are each configured to generate each instance P[n] of products P[1]-P[N] by always performing the multiplying operation. In some other embodiments, the one or more logic gates B1 are configured to output the differences D[1]-D[N] to the multiplier circuits 106, respectively, and the multiplier circuits 106 are each configured to generate each instance P[n] of products P[1]-P[N] by selectively performing the multiplying operation based on a corresponding instance D[n].

The comparator circuits 120 are each an electronic circuit, e.g., an IC, configured to receive, e.g., from the difference circuit 110, one of the corresponding differences D[1]-D[N] representing the difference between at least one of the exponent InE or the exponent WtE and the maximum exponent sum MaxExp. The comparator circuits 120 are configured to, in operation, compare the received differences D[1]-D[N] to an exponent sum threshold (e.g., sometimes referred to as an exponent difference threshold). The exponent sum threshold can be predefined or pre-configured for specific machine learning applications. The exponent sum threshold can be configured based on the desired precision for the output of the MAC operation.

In some configurations, the circuit 100 may set the exponent sum threshold based on the precision of the mantissa InM or the mantissa WtM (e.g., a portion of the input values) or the format of the input values (e.g., data elements from the input circuit 104). For example, the data elements InDE and WtDE can have FP16 format, including 1 sign bit, 5 exponent bits, and 10 mantissa bits. The output of the MAC operation (e.g., an output from the converter 118) can have the same or different format (e.g., FP32 format, including 1 sign bit, 8 exponent bits, and 23 mantissa bits, or other formats). In this case, the precision can be set to the number of bits (e.g., precision) of the mantissa InM or the mantissa WtM (e.g., 10 mantissa bits). As such, the exponent sum threshold can be configured as 10, as an example, such that the relatively small input values (e.g., corresponding exponent difference greater than or equal to the exponent sum difference), or the product from the multiplier circuit 106 thereof, can be ignored, e.g., by applying a mask or directly outputting zero from the multiplier circuit 106. In other words, in this case, a value can be considered relatively small, for instance, if an 11-bit right shift is to be performed by the shifting circuit 112.

In some configurations, the circuit 100 may set the exponent sum threshold based on a predetermined round-up value from the least significant bit (LSB), e.g., by configuring the exponent sum threshold as the number of mantissa bits plus a number of extra bits. For example, referring to the aforementioned examples, where the data elements InDE and WtDE can have FP16 format and the MAC operation output can have FP32 format, the circuit 100 can set the exponent sum threshold as the precision of the data elements plus one or more extra bits. In some cases, the extra bits can be predefined. In some other cases, the extra bits may be based on the specific architecture or implementation of the circuit 100 or CIM, where 6 extra bits can be set for 64-bit MAC CIM and 5 extra bits can be set for 32-bit MAC CIM. Using 6 extra bits as an example, the circuit 100 can set the exponent sum threshold as 16 (e.g., 10 mantissa bits associated with the data elements and 6 extra bits according to the specific architecture). As such, an exponent difference of at least 16 bits (from the maximum exponent sum MaxExp) can be considered relatively small, such that a masking procedure can be performed for or a product P[n] of zero can be generated from the corresponding multiplier circuit 106. The circuit 100 can update the extra bits for different precision.

The comparator circuits 120 are configured to, in operation, generate control signals C[1]-C[N] having the total number N corresponding to the total number N of at least one of the multiplier circuits 106, the summing circuits 108, and/or the differences D[1]-D[N]. The generated control signals C[1]-C[N] can be based on or according to the comparison of the differences D[1]-D[N] to the exponent sum threshold. Each of the comparator circuits 120 can generate a corresponding instance C[n] of the control signals C[1]-C[N]. The comparator circuits 120 can include one or more components capable of or suitable for executing the comparison and generation operations, for example.

For example, the comparator circuit 120 can generate the control signal C[n] based on whether the corresponding difference D[n] satisfies the exponent sum threshold (e.g., by performing the comparison). Satisfying the exponent sum threshold can refer to the difference D[n] being greater than or equal to the exponent sum threshold, for example. The control signal C[n] can be 0 or 1 depending on the result of the comparison. If the difference D[n] is less than the exponent sum threshold, the comparator circuit 120 can generate a control signal C[n] of 1. If the difference D[n] is greater than or equal to the exponent sum threshold, the comparator circuit 120 can generate a control signal C[n] of 0. In some configurations, the comparator circuit 120 can generate a control signal C[n] of 1 if the difference D[n] is greater than or equal to the exponent sum threshold and a control signal C[n] of 0 if the difference D[n] is less than the exponent sum threshold, for example. The comparator circuit 120 can provide the control signal C[n] to the corresponding multiplier circuit 106 or at least one component of the multiplier circuit 106 (e.g., the MUX 122 or the one or more logic gates M1).

It should be noted that the variables or values, such as the exponent sum threshold, the input values, the formats, etc., are not limited to the examples provided herein, and other variables or values can be used similarly by the circuit 100 or other devices or components thereof, such as different exponent sum thresholds, formats, etc., to perform the MAC operation for the floating point numbers with reduced computation resources. Further, it should be noted that more or less components and/or different arrangements of the one or more components can be implemented to perform the features, operations, or procedures discussed herein.

In various arrangements, the operations of at least one of the summing circuits 108, the difference circuit 110, and/or the comparator circuits 120 can be performed before, after, or in parallel to the multiplier circuits 106. In some arrangements, the operations of the individual summing circuits 108, the difference circuit 110, or the comparator circuits 120 may be performed sequentially or in parallel.

The shifting circuit 112 is an electronic circuit, e.g., an IC, including one or more registers and/or logic gates configured to perform a shifting operation on each instance P[n] of the products P[1]-P[N] based on the value of the corresponding instance D[n] of the differences D[1]-D[N].

Each instance P[n] of the products P[1]-P[N] is based on the sign and mantissa of a corresponding combination of data elements InDE and WtDE, and each instance D[n] of the differences D[1]-D[N] is based on the sum of the exponents of the same combination. The shifting circuit 112 is configured to, in operation, right-shift each instance P[n] of the products P[1]-P[N] by an amount equal to the corresponding difference D[n], thereby generating shifted products SP[1]-SP[N] in which sign and mantissa bits are aligned in accordance with the summed exponents used to generate the differences D[1]-D[N]. Based on this alignment, the shifting circuit 112 is configured to generate each instance SP[n] of the shifted products SP[1]-SP[N] having a same exponent using the maximum exponent sum MaxExp as a baseline.

To compensate for the right-shifting operation, the shifting circuit 112 can add instances of the sign bit (zero or one) of each product P[n] as the leftmost bits of the corresponding shifted product SP[n]. The number of added instances of the sign bit is equal to the amount of the right shift as determined by the corresponding difference D[n].

In the illustrated embodiment of FIG. 1, the multiplier circuit 106 can generate the corresponding instance P[n] of the products P[1]-P[N] by performing the multiplying operation, as discussed above. The shifting circuit 112 can include one or more shifters to receive the products P[1]-P[N] from the multiplier circuits 106, and selectively output (e.g., shift) one or more of the shifted products SP[1]-SP[N] to the adder circuit 114 based on the respective differences D[1]-D[N]. For example in FIG. 1, the shifted products outputted to the adder circuit 114 may include SP[w]-SP[z], where “w” to “z” may each be one of the integers from 1 to N. In one aspect of the present disclosure, a sum of the number of SP[w]-SP[z] may be equal to N. In another aspect of the present disclosure, a sum of the number of SP[w]-SP[z] may be less than N.

The shifting circuit 112 (e.g., the shifters) can be controlled (e.g., activated) by a number (e.g., N) of signals generated based on comparing corresponding ones of the differences D[1]-D[N] with a difference threshold (not shown in FIG. 1). The difference threshold can be configured based on a distribution of the differences D[1]-D[N]. In an example where the differences D[1]-D[N] are presented as a normal distribution, the difference threshold may be determined at one standard deviation below a mean of the normal distribution. In another example where the differences D[1]-D[N] are still presented as a normal distribution, the difference threshold may be determined at two standard deviations below a mean of the normal distribution. In yet another example where the differences D[1]-D[N] are still presented as a normal distribution, the difference threshold may be determined at any value of standard deviations below a mean of the normal distribution.

When any of the difference, e.g., D[n] where n is an integer between 1 to N, is equal to or less than the difference threshold (sometimes referred to as a “small exponent difference”), the shifting circuit 112 (e.g., the shifter) can be deactivated to block the corresponding shifted product SP[n] from being received by the adder circuit 114 (e.g., not shifting the corresponding product P[n] or being decoupled from the adder circuit 114). Equivalently, when any of the difference, e.g., D[n], is greater than the difference threshold (sometimes referred to as a “normal exponent difference”), the shifting circuit 112 can be activated to output the corresponding shifted product SP[n] to the adder circuit 114.

In other words, the shifting circuit 112 can shift any of the products P[1]-P[N], and output the shifted products SP[1]-SP[N] to the adder circuit 114 based on comparing the respective differences D[1]-D[N] with the difference threshold. As such, a sum of the number of SP[w]-SP[z] may be equal to N. In some configurations, the shifting circuit 112 may detect that at least one of the products P[1]-P[N] from the multiplier circuits 106 is zero. In such cases, the shifting circuit 112 may not perform a shift to the corresponding product with a value of zero and/or output the product to the adder circuit 114. As a result, the sum of the number of SP[w]-SP[z] may be less than N.

Further, to generate the SP[w]-SP[z], the shifting circuit 112 may right-shift each instance P[n] of the products P[w]-P[z] by an amount equal to a corresponding difference DA[n], thereby aligning sign and mantissa bits in accordance with the summed exponents. In some embodiments, the difference DA[n] may be generated (e.g., by the difference circuit 110) based on subtracting each data element of sums S[w]-S[z] from a maximum exponent sum MaxExp. The maximum exponent sum MaxExp may correspond to a maximum value of the data elements of the sums S[w]-S[z]. Based on this alignment, the shifting circuit 112 can generate each instance SP[n] of the shifted products SP[w]-SP[z] having a same exponent using the maximum exponent sum MaxExp as a baseline.

When any of the differences, e.g., D[n] where n is an integer between 1 to N, is equal to or less than the difference threshold (sometimes referred to as a “small exponent difference”), the shifting circuit 112 may be deactivated to block the corresponding (e.g., shifted) product SP[n] from being received by the adder circuit 114. The product P[n] with such a big exponent difference may be ignored, in some embodiments.

In other words, the shifting circuit 112 can shift all or some of the products P[1]-P[N], and selectively output the corresponding ones of the shifted products SP[1]-SP[N] to the adder circuit 114, based on comparing the respective differences D[1]-D[N] with the difference threshold. As such, a sum of the number of SP[w]-SP[z] (outputted by the shifting circuit 112) may be less than or equal to N. When one or more of the products P[1]-P[N] are ignored (e.g., having their respective exponent differences D[n] equal to or greater than the difference threshold), the sum is less than N; and when none of the products P[1]-P[N] is ignored, the sum is equal to N.

In some embodiments, the multiplier circuits 106 can receive the differences D[1]-D[N] from the difference circuit 110 to determine whether the difference D[n] is greater than or equal to the exponent sum threshold (e.g., sometimes referred to as an exponent difference threshold). As described herein, such as in conjunction with but not limited to at least one of FIGS. 2-10, the multiplier circuits 106 may receive the control signals C[1]-C[N] indicating whether the difference D[n] is greater than or equal to the exponent sum threshold. If the difference D[n] is greater than or equal to the exponent sum threshold, the corresponding multiplier circuit 106 can perform a masking operation on at least one of the corresponding mantissa InM, mantissa WtM, reformatted mantissa InTC, or reformatted mantissa WtTC, and/or provide an output of zero from the multiplier. In some implementations, if the difference D[n] is greater than or equal to the exponent sum threshold, the corresponding multiplier circuit 106 may ignore outputting the corresponding product (e.g., the result of the multiplier or zero) to the shifting circuit 112. As such, the number of products received by the shifting circuit 112 may be less than N, e.g., P[1] to P[N] except for one or more P[n]. The remaining one of the products P[1]-P[N] may then be shifted by the shifting circuit 112 based on comparing their respective differences D[1]-D[N] with the difference threshold.

In some embodiments, e.g., those in which the data elements InDE and WtDE have the BF16 format, the shifting circuit 112 is configured to generate each of the shifted products, e.g., the SP[0]-SP[N], having a total of 21 bits based on each of the products P[0]-P[N] having a total of 17 bits. In some embodiments, e.g., those in which the data elements InDE and WtDE have the FP16 format, the shifting circuit 112 is configured to generate each of the shifted products, e.g., the SP[0]-SP[N], having a total of 27 bits based on each of the products P[0]-P[N] having a total of 23 bits. The shifting circuit 112 being configured to generate each of the shifted products SP[0]-SP[N] having other total bit numbers based on each of the products P[0]-P[N] having other total bit numbers is within the scope of the present disclosure.

Based on the products P[0]-P[N] having a two's complement format, the shifting circuit 112 is configured to generate the shifted products, e.g., SP[0]-SP[N], having a two's complement format. As discussed above, in the illustrated example of FIG. 1, the shifting circuit 112 is configured to output the shifted products SP[w]-SP[z] to the adder circuit (tree) 114 on a data bus (not shown).

The adder tree 114 is an electronic circuit, e.g., an IC, including multiple layers of one or more logic gates (not shown), e.g., as discussed above with respect to one or more logic gates A1 (of the summing circuit 108). For example, the adder tree 114 may include a first layer configured to receive the shifted products SP[w]-SP[z], and a last layer configured to generate a sum 115 as a data element corresponding to a sum of the shifted products SP[w]-SP[z]. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

The sum PSTC (e.g., corresponding to the sum 115) is sometimes referred to as partial sum PSTC or mantissa sum PSTC in some embodiments, having a total number of bits corresponding to the number of bits and number of data elements of the shifted products SP[w]-SP[z]. In some embodiments, the number of bits of sum PSTC is equal to the number of bits of shifted products SP[w]-SP[z] plus a number of bits capable of representing the number of data elements of shifted products SP[w]-SP[z]. In some embodiments, the number of bits of sum PSTC is equal to the number of bits of shifted products SP[w]-SP[z] plus four bits capable of representing 16 data elements of shifted products SP[w]-SP[z].

In some embodiments, e.g., those in which data elements InDE and WtDE have the BF16 format, the adder tree 114 is configured to generate the sum PSTC having a total of 25 bits based on each of the shifted products SP[w]-SP[z] having a total of 21 bits. In some embodiments, e.g., those in which data elements InDE and WtDE have the FP16 format, the adder tree 114 is configured to generate the sum PSTC having a total of 31 bits based on each of the shifted products SP[w]-SP[z] having a total of 27 bits. The adder tree 114 being configured to generate the sum PSTC based on each of the shifted products SP[w]-SP[z] having other total bit numbers is within the scope of the present disclosure.

Based on the shifted products SP[w]-SP[z] having a two's complement format, the adder tree 114 is configured to generate the sum PSTC having a two's complement format, in accordance with various embodiments of the present disclosure. As such, the adder tree 114 is configured to output the sum PSTC to the converter 116 on a data bus (not shown). In some other embodiments, the adder tree 114 may output the sum PSTC to a circuit (not shown) external to the circuit 100.

The converter 116 is an electronic circuit, e.g., an IC, including logic circuitry configured to, in operation, receive the sum PSTC from the adder tree 114, and convert the sum PSTC from two's complement to a sum PSSM having a sign plus mantissa format. The converter 116 is configured to generate the sum PSSM having a same number of bits as that of the sum PSTC. In the embodiment depicted in FIG. 1, the converter 116 is configured to further output the sum PSSM to the converter 118 on a data bus (not shown). In some other embodiments, the converter 116 may output the sum PSSM to a circuit (not shown) external to the circuit 100.

The converter 118 is an electronic circuit, e.g., an IC, including logic circuitry configured to, in operation, receive the sum PSSM from the converter 116 and the maximum exponent sum MaxExp from the difference circuit 110, and convert the sum PSSM from the sign plus mantissa format to a sum PS having an output format based on the sum PSSM and the MaxExp and different from the sign plus mantissa format, e.g., a floating point format as discussed above. In various embodiments of the present disclosure, the converter 118 can generate the sum PS configured to be compatible with a circuit (not shown) external to the circuit 100. For example, the converter 118 is configured to output the sum PS to a circuit (not shown) external to the circuit 100, e.g., a memory array or other instance of the circuit 100 as part of a convolutional neural network (CNN). In some arrangements, the converter 116 can be a part of the converter 118, or vice versa.

FIG. 2 illustrates a block diagram of a portion 200 of the data computation circuit 100 of FIG. 1 for masking an input mantissa, in accordance with some embodiments. The portion 200 can include one or more components of the circuit 100, such as but not limited to the multiplier circuits 106, the summing circuits 108, the difference circuit 110, and the comparator circuits 120. The portion 200 can include other components to perform in-memory computations (e.g., MAC operations) on an input word vector and a weight matrix. The input word vector can include a plural number (N) of input data elements InDE (e.g., first inputs), and the weight matrix can include a plural number (N) of weight data elements WtDE (e.g., second inputs). In various embodiments, each of the input data elements InDE and the weight data elements WtDE may include a floating point number.

Each of the weight data elements WtDE and a corresponding one of the input data elements InDE can form or be referred to as one of a number (N) of input pairs. In various implementations, the input data elements InDE and the weight data elements WtDE can each include a respective sign portion, exponent portion, and mantissa portion. For example, the input data elements InDE (e.g., the first inputs) can include a number (N) of first signs, a number (N) of first exponents, and a number (N) of first mantissas. The weight data elements WtDE can include a number (N) of second signs, a number (N) of second exponents, and a number (N) of second mantissas.

The multiplier circuit 106 can receive the signed mantissas InS/InM (e.g., sometimes referred to as “XIN mantissa”) and WtS/WtM (e.g., stored in the mantissa buffer) as inputs. In some cases, the multiplier circuit 106 can reformat each instance of the signed mantissas InS/InM and WtS/WtM to their respective two's complement (e.g., reformatted) mantissa InTC and WtTc. The summing circuit 108 can receive the exponent InE (e.g., sometimes referred to as “XIN Exp”) and the exponent WtE (e.g., stored in the exponent buffer) as the inputs. For simplicity and for purposes of providing examples herein, FIG. 2 provides the mantissas InM and WtM (e.g., mantissa portions) as the inputs to the multiplier circuit 106 (or the logic gate M1), although it should be noted that the signed bit or the reformatted mantissas InTC and WtTc can be provided as the inputs to the multiplier circuit 106 (or the logic gate M1).

The difference circuit 110 of FIG. 2 can include the various components as described in conjunction with but not limited to FIG. 1. For example, the difference circuit 110 can receive the exponent sums (e.g., S[1]-S[N]) from the summing circuits 108. The difference circuit 110 can identify, select, or determine the maximum exponent sum MaxExp from the exponent sums S[1]-S[N]. For a respective summing circuit 108, the difference circuit 110 can generate or determine a corresponding exponent difference (e.g., a corresponding difference D[n]) based on the difference between the maximum exponent sum MaxExp and the corresponding exponent sum. The difference circuit 110 can generate and provide the differences D[1]-D[N] to the corresponding comparator circuits 120.

As described in conjunction with at least FIG. 1, each of the comparator circuits 120 can receive and compare the difference D[n] (e.g., sometimes referred to as exponent difference) for the corresponding input pair to the exponent sum threshold. The comparator circuit 120 can generate a control signal (e.g., C[n]) according to the comparison. For example, the comparator circuit 120 can generate a control signal of 0 if the difference is greater than or equal to the exponent sum threshold. In another example, the comparator circuit 120 can generate a control signal of 1 if the difference is less than the exponent sum threshold. The comparator circuit 120 can send the control signal to the multiplier circuit 106. It should be noted that the components of FIG. 2 may be a simplified version of the components of the circuit 100 of FIG. 1, for purposes of providing examples, and may include additional or alternative components to perform the MAC operation for the floating point numbers with reduced computation resources discussed herein.

In this case, the multiplier circuit 106 can include a MUX 122 for masking the XIN mantissa to reduce the computation resource if the difference is greater than the exponent sum threshold. The inputs to the MUX 122 can include a predefined value of zero, the XIN mantissa, and the control signal from the comparator circuit 120. For example, if the difference (from a corresponding summing circuit 108) is less than the exponent sum threshold, the MUX 122 can receive the control signal of 1 from the comparator circuit 120. According to the control signal of 1, the MUX 122 can output the XIN mantissa to the one or more logic gates M1 of the corresponding multiplier circuit 106 for multiplication with at least the WtM from the mantissa buffer. In this example, the output from the one or more logic gates M1 can be a product of at least the input mantissas (e.g., XIN mantissa (or InM) and WtM).

In another example, if the difference is greater than or equal to the exponent sum threshold, the MUX 122 can receive the control signal of 0 from the comparator circuit 120. According to the control signal of 1, the MUX 122 can output 0 (e.g., masking the mantissa or changing the mantissa values to 0) to the one or more logic gates M1 of the corresponding multiplier circuit 106 for the multiplication with at least the WtM from the mantissa buffer, thereby reducing resource consumption during the multiplication process (and the accumulation process by at least the adder circuit 114). In this example, the output from the one or more logic gates M1 can be 0.

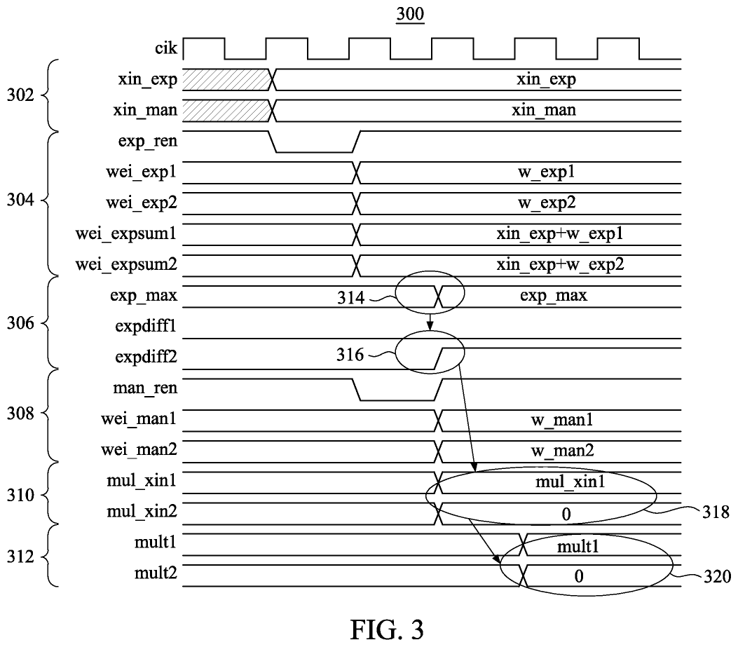

FIG. 3 is a timing diagram 300 of the data computation circuit 100 of FIG. 1 performing the MAC operations on the floating point numbers, in accordance with some embodiments. The operations associated with the timing diagram 300 may be implemented or performed by the components described in conjunction with but not limited to at least FIGS. 1 and 2. For example, at clock cycle 302, portions of the input data element InDE (e.g., at least the exponent InE and the mantissa InM) can be set or read from the input circuit 104. At clock cycle 304, one or more weight exponents (e.g., exponent WtE) can be read and summed with the corresponding input exponent InE.

At clock cycle 306, the maximum exponent sum (e.g., MaxExp) can be determined, as shown in example portion 314. For a corresponding exponent sum, in example portion 316, the circuit 100 (e.g., the difference circuit 110) can determine a corresponding exponent difference, e.g., D[n]. Based on the exponent difference, the circuit 100 (e.g., comparator circuit 120) can determine whether to apply a mask (e.g., zero the mantissa(s), the multiplier output, or the output of the corresponding multiplier circuit 106) based on a comparison of the exponent difference and the exponent sum threshold.

At clock cycle 308, the circuit 100 (e.g., the multiplier circuit 106) can read out the weight mantissa WtM. At clock cycle 310, the circuit 100 (e.g., the multiplier circuit 106) can multiply the input mantissa InM by either the weight mantissa WtM or zero based on the comparison of the corresponding exponent difference and the exponent sum threshold, e.g., at portion 318.

At clock cycle 312, the circuit 100 (e.g., the multiplier circuit 106) can generate a result of the multiplication (e.g., from the one or more logic gates M1). As shown in portion 320, the result of the multiplication can be the product of the input mantissa and the weight mantissa, e.g., if the exponent difference is less than the exponent sum threshold. Further, as shown in portion 320, the result (of the multiplier circuit 106) can be zero, e.g., if the exponent difference is greater than or equal to the exponent sum threshold. It should be noted that the clock cycles 302-312 of the timing diagram 300 are provided as non-limiting examples, and different operations performed by the circuit 100 can generate a different timing diagram, not limited to the timing diagram 300, for example.

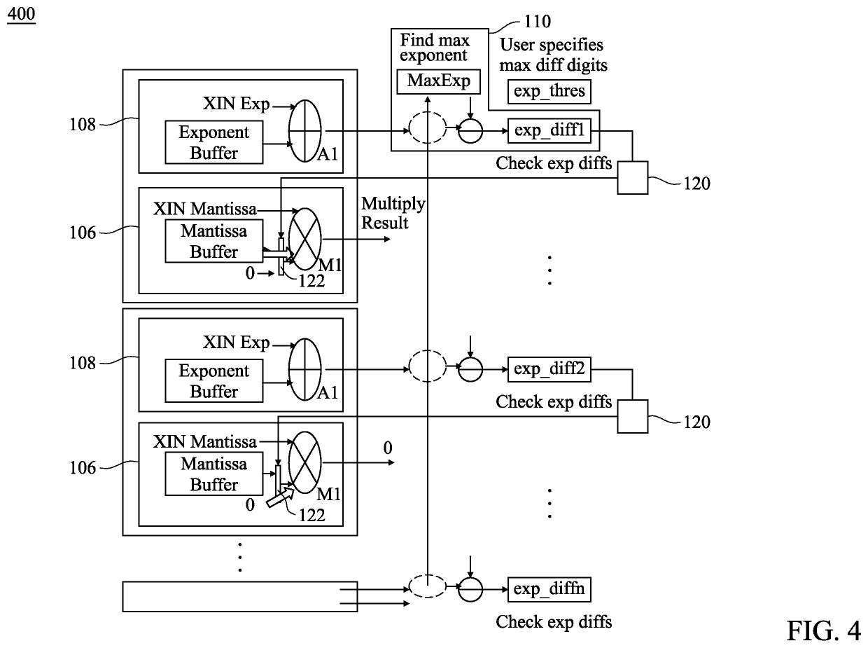

FIG. 4 is a block diagram of a portion 400 of the data computation circuit 100 of FIG. 1 for masking a weight mantissa, in accordance with some embodiments. The portion 400 can include one or more components of the circuit 100 similar to or described in conjunction with at least one of but not limited to FIG. 1 or 2. Certain operations of the one or more components of FIG. 4 can be similar to or described in conjunction with at least one of but not limited to FIG. 1 or 2. For example, the multiplier circuits 106 can be configured, in operation, to multiply at least the mantissas of the pairs of input values (e.g., data elements InDE and WtDE). The summing circuit 108 can be configured, in operation, to sum the exponents of the pairs of input values. The difference circuit 110 can be configured, in operation, to obtain the maximum exponent sum and the differences (e.g., exponent differences) between corresponding exponent sums and the maximum exponent sum. The comparator circuits 120 can be configured, in operation, to compare the differences to the (predefined or configured) exponent sum threshold and output corresponding control signals (e.g., C[1]-C[N]) to the multiplier circuit 106.

As shown in FIG. 4, the multiplier circuit 106 can include a MUX 122 between the mantissa buffer and the one or more logic gates M1 (e.g., the multiplier). In this case, the MUX 122 can receive the weight mantissa (e.g., WtM) from the mantissa buffer, zero, and the control signal via the input ports. The MUX 122 can include an output port coupled to the one or more logic gates M1 (e.g., the multiplier) for outputting a selected input based on the control signal. The MUX 122 can be provided to mask the weight mantissa (e.g., WtM) from the mantissa buffer based on the comparison of the exponent difference and the exponent sum threshold.

For example, the comparator circuit 120 may determine that the difference is greater than or equal to the exponent sum threshold. In response to the determination, the comparator circuit 120 can send a control signal (e.g., 0) to the MUX 122 to mask the weight mantissa WtM by selecting 0 as the output to multiply with the corresponding input mantissa InM (e.g., XIN mantissa). In such cases, the one or more logic gates M1 can receive the 0 from the MUX 122 and the XIN mantissa, which results in a product of 0.

In another example, the comparator circuit 120 may determine that the difference is less than the exponent sum threshold. In response to the determination, the comparator circuit 120 can send a control signal (e.g., 1) to the MUX 122 to not mask the original value from the input circuit 104, e.g., select the weight mantissa WtM as the output to multiply with the corresponding XIN mantissa. In this case, the one or more logic gates M1 can receive the weight mantissa and the XIN mantissa. Accordingly, the corresponding multiplier circuit 106 (e.g., the one or more logic gates M1) can output a product between the weight mantissa and the XIN mantissa.

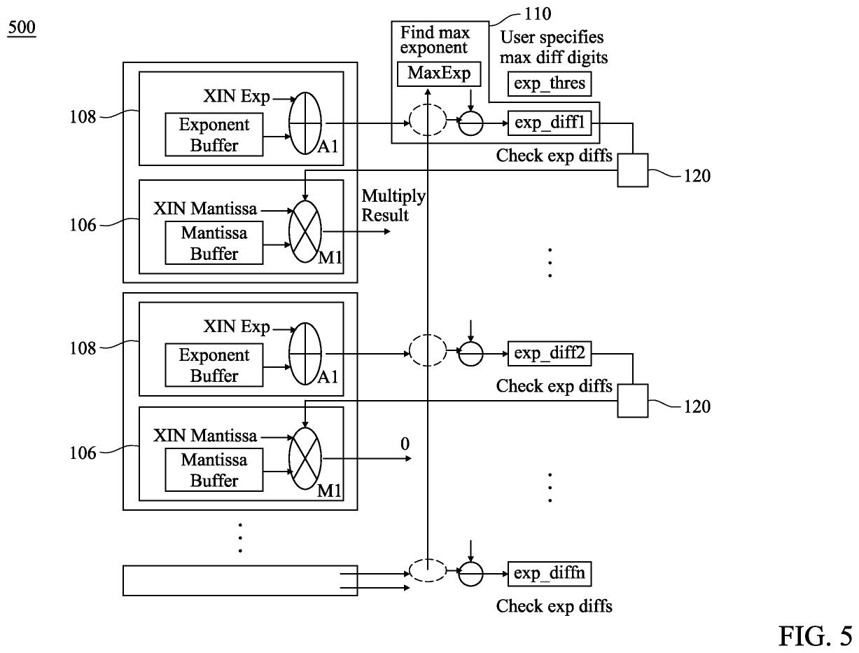

FIG. 5 is a block diagram of a portion 500 of the data computation circuit of FIG. 1 for masking a multiplier output, in accordance with some embodiments. The portion 500 can include one or more components of the circuit 100 similar to or described in conjunction with at least one of but not limited to FIG. 1, 2, or 4. Certain operations of the one or more components of FIG. 5 can be similar to or described in conjunction with at least one of but not limited to FIG. 1, 2, or 4. For example, the multiplier circuits 106 can be configured, in operation, to multiply at least the mantissas of the pairs of input values (e.g., data elements InDE and WtDE). The summing circuit 108 can be configured, in operation, to sum the exponents of the pairs of input values. The difference circuit 110 can be configured, in operation, to obtain the maximum exponent sum and the differences (e.g., exponent differences) between corresponding exponent sums and the maximum exponent sum. The comparator circuits 120 can be configured, in operation, to compare the differences to the (predefined or configured) exponent sum threshold and output corresponding control signals (e.g., C[1]-C[N]) to the multiplier circuit 106.

As shown in FIG. 5, the one or more logic gates M1 of the multiplier circuits 106 can be configured to receive the control signal from the comparator circuit 120. In this case, the control signal from the comparator circuit 120 can be a third input for the multiplier to mask the corresponding mantissa product according to the respective control signal based on the corresponding exponent difference compared to the exponent sum threshold. For example, the comparator circuit 120 may determine that the difference is greater than or equal to the exponent sum threshold. In response to the determination, the comparator circuit 120 can output a corresponding control signal (e.g., 0) to the one or more logic gates M1 (e.g., to the multiplier) for masking the corresponding mantissa product with 0. In this case, the multiplier can further multiply the product of the mantissas InM and WtM by 0 to reduce the computation resource of the MAC operation.

In another example, the comparator circuit 120 may determine that the difference is less than the exponent sum threshold. In response to the determination, the comparator circuit 120 can output a corresponding control signal (e.g., 1) to the multiplier to not mask the corresponding mantissa product. For instance, the multiplier can multiply the product of the mantissas InM and WtM by 1. Accordingly, the resulting product from the multiplier (e.g., the one or more logic gates M1) can remain the same (e.g., InM multiplied by WtM).

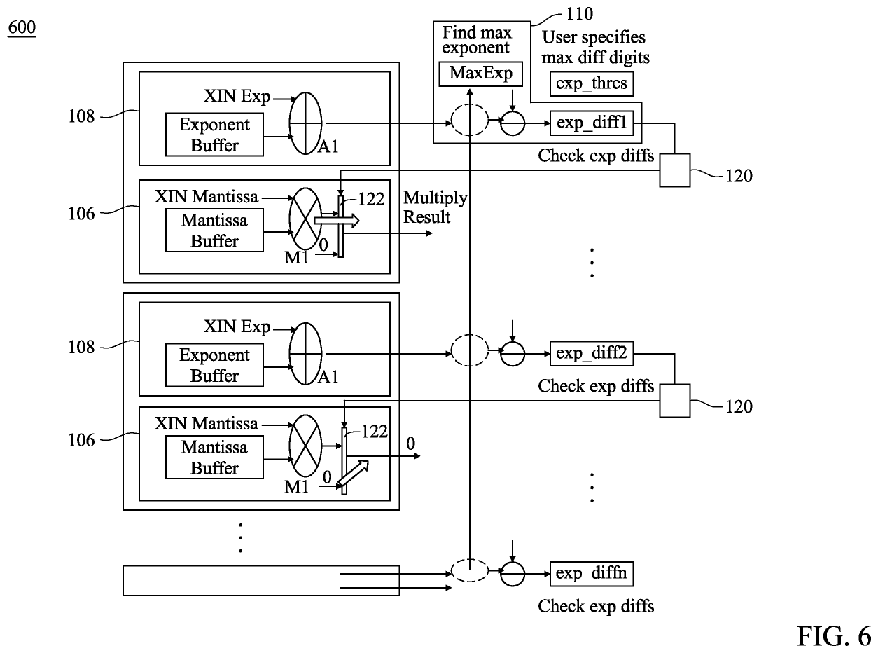

FIG. 6 is a block diagram of a portion 600 of the data computation circuit of FIG. 1 for directly outputting a result of the multiplier, in accordance with some embodiments. The portion 600 can include one or more components of the circuit 100 similar to or described in conjunction with at least one of but not limited to FIG. 1, 2, 4, or 5. Certain operations of the one or more components of FIG. 6 can be similar to or described in conjunction with at least one of but not limited to FIG. 1, 2, 4, or 5. For example, the multiplier circuits 106 can be configured, in operation, to multiply at least the mantissas of the pairs of input values (e.g., data elements InDE and WtDE). The summing circuit 108 can be configured, in operation, to sum the exponents of the pairs of input values. The difference circuit 110 can be configured, in operation, to obtain the maximum exponent sum and the differences (e.g., exponent differences) between corresponding exponent sums and the maximum exponent sum. The comparator circuits 120 can be configured, in operation, to compare the differences to the (predefined or configured) exponent sum threshold and output corresponding control signals (e.g., C[1]-C[N]) to the multiplier circuit 106.

As shown in FIG. 6, the multiplier circuit 106 can include a MUX 122 at the output of the one or more logic gates M1 (e.g., the multiplier). In this case, the MUX 122 can receive the corresponding product (e.g., P[n]) of the multiplier, zero, and the control signal via the input ports. The MUX 122 can include an output port coupled to the shifting circuit 112 for outputting a selected input based on the control signal, for example. The MUX 122 can be provided to directly output zero depending on the comparison of the exponent difference and the exponent sum threshold.

For example, the comparator circuit 120 may determine that the difference is greater than or equal to the exponent sum threshold. In response to the determination, the comparator circuit 120 can send a control signal (e.g., 0) to the MUX 122 to directly output zero from the multiplier circuit 106. In such cases, the shifting circuit 112 can receive the 0 from the MUX 122. In some other cases, the multiplier circuit 106 may be turned off or the clock supply can be stopped/paused for at least one cycle, for instance, if the output from the multiplier is 0 or if the control signal of 0 is provided by the comparator circuit 120 when the corresponding difference is greater than or equal to the exponent sum threshold.

In another example, the comparator circuit 120 may determine that the difference is less than the exponent sum threshold. In response to the determination, the comparator circuit 120 can send a control signal (e.g., 1) to the MUX 122 to output the product (e.g., the original result) from the multiplier, e.g., select the product of the mantissas InM and WtM as the output from the multiplier circuit 106. In this case, the output selected by the MUX 122 according to the control signal can be provided to the shifting circuit 112.

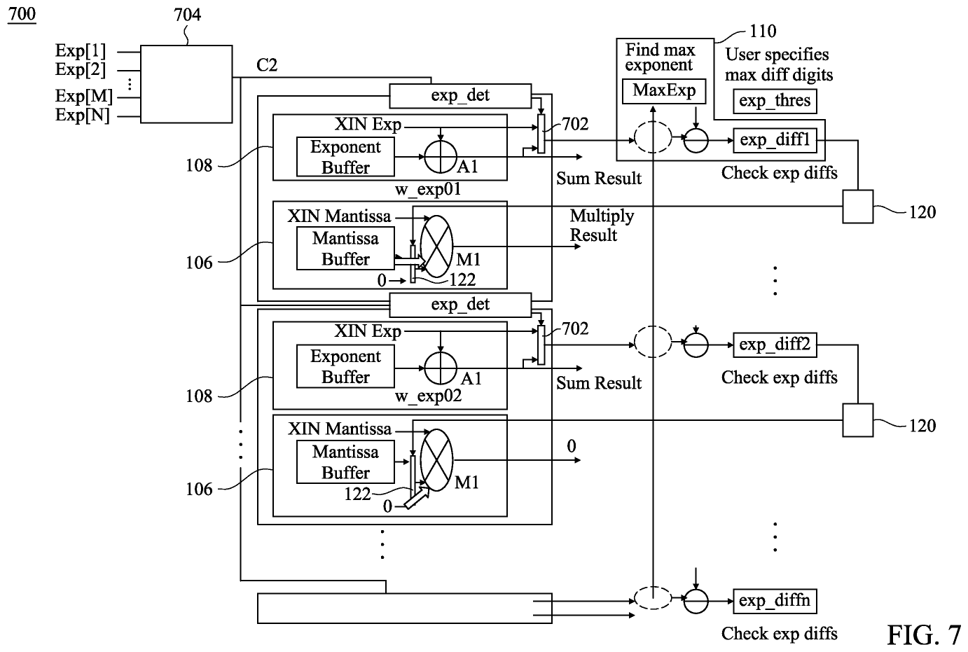

FIG. 7 is a block diagram of a portion 700 of the data computation circuit of FIG. 1 for masking the weight mantissa including a similarity circuit 704 (e.g., sometimes referred to as a second comparator circuit) for weight exponents, in accordance with some embodiments. The portion 700 can include one or more components of the circuit 100 similar to or described in conjunction with at least one of but not limited to FIG. 1, 2, 4, 5, or 6. Certain operations of the one or more components of FIG. 7 can be similar to or described in conjunction with at least one of but not limited to FIG. 1, 2, 4, 5, or 6. For example, the multiplier circuits 106 can be configured, in operation, to multiply at least the mantissas of the pairs of input values (e.g., data elements InDE and WtDE). The summing circuit 108 can be configured, in operation, to sum the exponents of the pairs of input values. In some cases, the summing circuit 108 can output the sum result (e.g., the result of summing a respective pair of exponents) because of the FP data format, such as for alignment and scaling purposes of the result according to the FP data format, or to provide information on overflow or underflow conditions, for example. The difference circuit 110 can be configured, in operation, to obtain the maximum exponent sum and the differences (e.g., exponent differences) between corresponding exponent sums and the maximum exponent sum. The comparator circuits 120 can be configured, in operation, to compare the differences to the (predefined or configured) exponent sum threshold and output corresponding control signals (e.g., C[1]-C[N]) to the multiplier circuit 106.

As shown in FIG. 7, the multiplier circuit 106 can include the MUX 122 similar to that which is described in conjunction with at least FIG. 4 (e.g., for masking the weight mantissa WtM based on the control signal). In particular, the operations or features of the multiplier circuit 106 can be described in conjunction with at least FIG. 4. Further, as shown in FIG. 7, the circuit 100 can include a second MUX (e.g., MUX 702) configured, in operation, e.g., to receive corresponding inputs, select one of the inputs according to a control signal, and output the selected input to the difference circuit 110. Although the MUX 702 is used for the purposes of providing examples, it should be noted that other logic components can be utilized similarly to output one of the inputs according to a control signal.

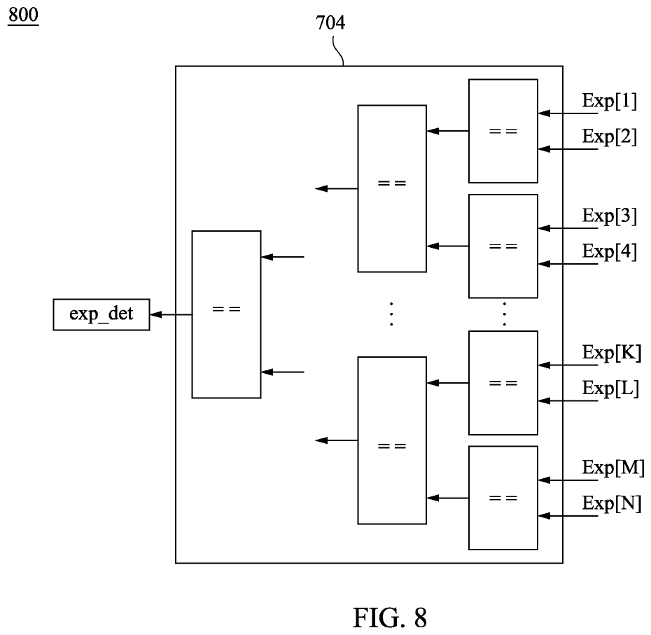

As further shown in FIG. 7, the circuit 100 can include a similarity circuit 704. The similarity circuit 704 can be configured, in operation, to determine whether each of the N exponents (e.g., the input exponents InE or the weight exponents WtE) is the same across the data elements (e.g., the input data elements InDE or the weight data elements WtDE) and generate a control signal C2 (e.g., sometimes referred to as a second control signal) according to the determination. For instance, depending on whether the corresponding exponents (e.g., either the input exponents or the weight exponents) from the input circuit 104 are the same, the summing circuits 108 (e.g., via the MUX 702) can either provide corresponding exponent sums S[1]-S[N] or the other corresponding exponents (e.g., the weight exponents or the input exponents) to the difference circuit 110. In such cases, the difference circuit 110 can determine the maximum exponent sum MaxExp and the differences D[1]-D[N] based on the provided exponents sums S[1]-S[N] or the provided exponents (e.g., the input exponents InE or the weight exponents WtE). The features or operations of the similarity circuit 704 can be described in conjunction with at least FIG. 8.

For example, referring to FIG. 8, a block diagram 800 is depicted of the similarity circuit 704 of at least FIG. 7 to determine whether the exponents are the same, in accordance with some embodiments. The similarity circuit 704 is an electronic circuit, e.g., an IC, configured to receive, e.g., from the input circuit 104, the exponent InE of each of the N data elements InDE (e.g., to determine whether the input exponents are the same) or the exponent WtE of each of the N data elements WtDE (e.g., to determine whether the weight exponents are the same). The similarity circuit 704 can be coupled to the input circuit 104 (not shown in FIG. 1) to receive the input exponents or the weight exponents.

The similarity circuit 704 can include one or more logic components for comparing pairs of exponents to determine whether each pair of exponents is the same. The similarity circuit 704 can include multiple layers of the one or more logic components. For instance, the similarity circuit 704 can include a first logic gate to compare a first exponent with a second exponent and a second logic gate to compare a third exponent with a fourth exponent. The first logic gate and the second logic gate can generate a respective output based on the comparison, such as 0 for a dissimilar pair of exponents and 1 for a similar pair of exponents. The first logic gate and the second logic gate can output the respective results of the comparison as a pair of inputs to a third logic gate. Similar processes for comparing the exponents or comparing the results from the prior comparison(s) can be iterated to reach a final logic gate.

The output from the final logic gate can correspond to the control signal C2, indicating whether all the exponents are the same or if at least one of the exponents is different from others. As such, for example, the similarity circuit 704 can output a control signal C2 of 1 if all the exponents are the same and a control signal C2 of 0 if at least one of the exponents is not the same as others. The similarity circuit 704 can provide the control signal C2 to the summing circuit 108 (e.g., the MUX 702). If the inputs of the similarity circuit 704 are the input exponents InE, the output (e.g., the control signal C2) from the similarity circuit 704 can indicate whether the input exponents InE are the same. In this case, the control signal C2 can dictate whether the summing circuits 108 output the corresponding exponent sums S[1]-S[N] or the corresponding weight exponents WtE to the difference circuit 110.

If the inputs of the similarity circuit 704 are the weight exponents WtE, the output from the similarity circuit 704 can indicate whether the weight exponents WtE are the same. In this case, the control signal C2 can dictate whether the summing circuits 108 output the corresponding exponent sums S[1]-S[N] or the corresponding input exponents InE to the difference circuit 110.

Referring back to FIG. 7, as shown, the similarity circuit 704 can provide the control signal C2 to the MUX 702. In this case, the similarity circuit 704 is used to determine the similarities between the weight exponents WtE. As such, the inputs to the MUX 702 can include the corresponding exponent sum S[n] from the one or more logic gates A1 and the corresponding input exponent InE. Based on the control signal C2, the MUX 702 can select one of the exponent sum S[n] or the input exponent InE as the output to the difference circuit 110.

For example, if the similarity circuit 704 determines that the weight exponents WtE are all the same, the similarity circuit 704 can send control signal C2 of 1 for the MUXs 702 to select the corresponding input exponents InE for the difference circuit 110. In another example, if the similarity circuit 704 determines that at least one of the weight exponent WtE is different than the others, the similarity circuit 704 can send control signal C2 of 0 for the MUXs 702 to select the corresponding exponent sums S[1]-S[N] for the difference circuit 110. Accordingly, the difference circuit 110 can use either the exponent sums S[1]-S[N] or the input exponents InE from the summing circuits 108 to determine the maximum exponent sum MaxExp and the corresponding exponent differences, e.g., which can be further provided to at least the shifting circuit 112 and the comparator circuit 120.

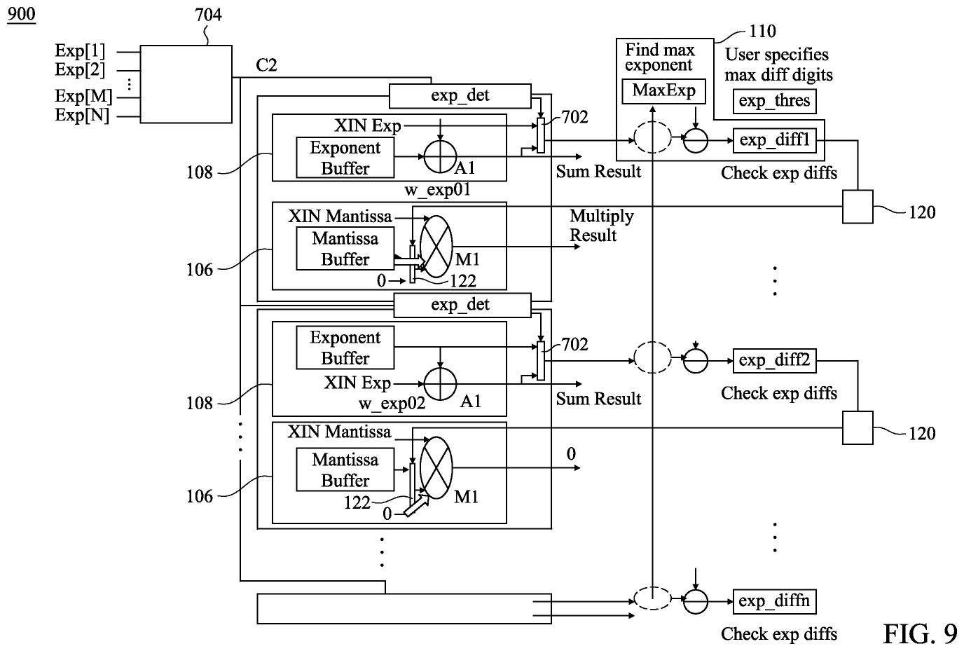

FIG. 9 is a block diagram of a portion 900 of the data computation circuit 100 of FIG. 1 for masking the weight mantissa including a similarity circuit 704 for input exponents, in accordance with some embodiments. The portion 900 can include one or more components of the circuit 100 similar to or described in conjunction with at least one of but not limited to FIG. 1, 2, 4, 5, 6, 7, or 8. Certain operations of the one or more components of FIG. 9 can be similar to or described in conjunction with at least one of but not limited to FIG. 1, 2, 4, 5, 6, 7, or 8. For example, the multiplier circuits 106 can be configured, in operation, to multiply at least the mantissas of the pairs of input values (e.g., data elements InDE and WtDE). The summing circuit 108 can be configured, in operation, to sum the exponents of the pairs of input values. The difference circuit 110 can be configured, in operation, to obtain the maximum exponent sum and the differences (e.g., exponent differences) between corresponding exponent sums and the maximum exponent sum. The comparator circuits 120 can be configured, in operation, to compare the differences to the (predefined or configured) exponent sum threshold and output corresponding control signals (e.g., C[1]-C[N]) to the multiplier circuit 106.

As shown in FIG. 9, the multiplier circuit 106 can include the MUX 122 similar to that which is described in conjunction with at least FIG. 4 (e.g., for masking the weight mantissa WtM based on the control signal). In particular, the operations or features of the multiplier circuit 106 can be described in conjunction with at least FIG. 4. Further, as shown in FIG. 9, the circuit 100 can include the MUX 702 configured, in operation, e.g., to receive the control signal C2 from the similarity circuit 704 and select one of the inputs based on the control signal C2.

In this case, the similarity circuit 704 can be configured, in operation, to determine whether each of the input exponents InE is the same as other input exponents InE for the input data elements InDE and generate a control signal C2 according to the determination. With the similarity circuit 704 utilized to determine the similarities between the input exponents InE, the inputs to the MUX 702 can include the corresponding exponent sum S[n] from the one or more logic gates A1 and the corresponding weight exponent WtE. Based on the control signal C2, the MUX 702 can select one of the exponent sum S[n] or the input exponent InE as the output to the difference circuit 110.

For example, if the similarity circuit 704 determines that the input exponents InE are all the same, the similarity circuit 704 can send control signal C2 of 1 for the MUXs 702 to select the corresponding weight exponents WtE for the difference circuit 110. In another example, if the similarity circuit 704 determines that at least one of the input exponent InE is different than the others, the similarity circuit 704 can send control signal C2 of 0 for the MUXs 702 to select the corresponding exponent sums S[1]-S[N] for the difference circuit 110. Accordingly, the difference circuit 110 can use either the exponent sums S[1]-S[N] or the weight exponents WtE from the summing circuits 108 to determine the maximum exponent sum MaxExp and the corresponding exponent differences, e.g., which can be further provided to at least the shifting circuit 112 and the comparator circuit 120.

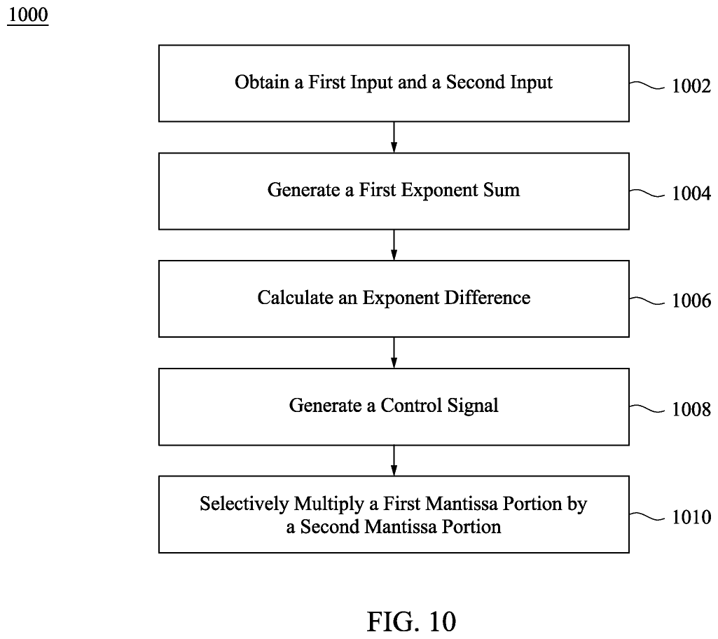

FIG. 10 illustrates a flow chart of an example method 1000 of performing MAC operations on floating point numbers with reduced computation resources, in accordance with various embodiments. The example method 1000 can be performed by the circuit 100 or one or more components of the circuit 100. As such, the following embodiment of the method 1000 can be described in conjunction with but not limited to at least one of FIGS. 1-9. The illustrated embodiment of the method 1000 is provided as an example and does not limit the scope of the present disclosure. Therefore, it shall be understood that any of a variety of the operations of the method 1000 may be omitted, re-sequenced, and/or added while remaining within the scope of the present disclosure.

The method 1000 starts with operation 1002 for obtaining a first input and a second input, in accordance with various embodiments. The circuit 100 (e.g., sometimes referred to as CIM circuit 100) can obtain the first input and the second input from the input circuit 104, for example. Each of the inputs can include at least an exponent portion and a mantissa portion. For instance, the first input can include a first exponent portion and a first mantissa portion. The second input can include a second exponent portion and a second mantissa portion. Each of the inputs may further include a sign bit. In various implementations, the circuit 100 can obtain multiple first inputs and second inputs. The first inputs can consist of a number (N) of first signs, N first exponents, and N first mantissas. The second inputs can consist of N second signs, N second exponents, and N second mantissas. Each of the second inputs and a corresponding one of the N first inputs form one of N input pairs. The inputs can correspond to the data elements, such as the input data element InDE or the weight data element WtDE.

The method 1000 continues to operation 1004 for generating a first exponent sum, in accordance with various embodiments. The circuit 100 (e.g., summing circuit 108) can generate the first exponent sum (e.g., S[n]) by summing the first exponent portion of the first input and the second exponent portion of the second input. The circuit 100 can include N summing circuits 108 configured to combine (or add) the corresponding first exponent and the corresponding second exponent of a corresponding one of the N input pairs to generate a respective one of N exponent sums (e.g., S[1]-S[N]).

The method 1000 continues to operation 1006 for calculating an exponent difference, in accordance with various embodiments. The circuit 100 (e.g., difference circuit 110, sometimes referred to as a subtractor circuit) can calculate or determine the exponent difference by subtracting the first exponent sum S[n] from a largest exponent sum (e.g., the maximum exponent sum MaxExp). For example, the circuit 100 can receive the N exponent sums from the corresponding summing circuits 108. The circuit 100 can include a selector circuit 111 configured to select or identify the largest one among the N exponent sums as a largest or maximum exponent sum. In response to identifying the maximum exponent sum, each of the difference circuits 110 (or the subtractor circuits) of the circuit 100 can calculate or determine the corresponding one of N exponent differences by subtracting the maximum exponent sum by the corresponding exponent sum from the summing circuit 108. In other words, each of the N exponent differences can be equal to a difference between a corresponding one of the N exponent sums and the largest exponent sum.

The method 1000 continues to operation 1008 for generating a control signal, in accordance with various embodiments. The circuit 100 (e.g., comparator circuit 120) can generate a control signal (e.g., C[n]) based on comparing the exponent difference with an exponent sum threshold. The exponent sum threshold can be predefined or configured according to the application or implementation. The circuit 100 can include N comparator circuits (e.g., 120), each configured to compare the corresponding exponent difference with an exponent sum threshold and generate a corresponding one of N control signals (e.g., C[1]-C[N]) based on the comparison between the corresponding exponent difference and the exponent sum threshold. For example, if the exponent difference is greater than or equal to the exponent sum threshold, the comparator circuit 120 can generate a first control signal (e.g., 0). In another example, if the exponent difference is less than the exponent sum threshold, the comparator circuit 120 can generate a second control signal (e.g., 1). The N comparator circuits 120 can provide the corresponding control signals C[1]-C[N] to the corresponding multiplier circuits 106 for masking operations or for outputting a value of zero based on the control signal.

The method 1000 continues to operation 1010 for selectively multiplying a first mantissa portion by a second mantissa portion, in accordance with various embodiments. The circuit 100 (e.g., multiplier circuit 106) can selectively multiply the first mantissa portion by the second mantissa portion based on the respective control signal (e.g., C[n]), to generate a mantissa product (e.g., either zero or the product of the first and second mantissa portions dictated by the control signal). In various configurations, the circuit 100 can include N multiplier circuits 106. Each of the N multiplier circuits 106 can be configured to selectively multiply the corresponding first mantissa by the corresponding second mantissa of the corresponding input pair based on the respective control signal, so as to generate a corresponding one of N mantissa products.

In various implementations, the circuit 100 can include N multiplexers (e.g., MUX 122) associated with the corresponding N multiplier circuits 106. Each of the N multiplexers can receive the corresponding one of the N control signals from the corresponding one of the N comparator circuits (e.g., 120), a first input, and a second input. The first input can be zero. The second input can be one of the corresponding first mantissa, the corresponding second mantissa, or the corresponding mantissa product depending on the configuration, arrangement, or implementation of the N multiplexers, such as described in conjunction with at least one of but not limited to FIGS. 1-9. In such cases, the circuit 100 can output one of the first input or the second input according to the respective control signal, e.g., based on whether the corresponding exponent difference is greater than or equal to the exponent sum threshold.

In some implementations, the circuit 100 (e.g., the multiplier circuit 106) can include a multiplexer (e.g., MUX 122) for masking the first mantissa (e.g., input mantissa InM), such as described in conjunction with at least FIG. 2. For example, the multiplexer can receive the respective control signal (e.g., C[n]) from the comparator circuit 120, the corresponding first mantissa from the input circuit 104, and zero. The multiplexer can select, according to the respective control signal, the corresponding first mantissa as an output to multiply with the corresponding second mantissa via the one or more logic gates M1 (e.g., the multiplier) based on the corresponding exponent difference being less than the exponent sum threshold. The multiplexer can select, according to the respective control signal, the zero as an output to multiply with the corresponding second mantissa based on the corresponding exponent difference being greater than or equal to the exponent sum threshold. In this case, the multiplexer can mask the first mantissa because the corresponding pair of inputs is considered relatively small based on the exponent difference. Hence, the circuit 100 can reduce computation resources by converting the first mantissa to zero and multiplying the second mantissa by zero, for example.

In some implementations, the circuit 100 (e.g., the multiplier circuit 106) can include a multiplexer (e.g., MUX 122) for masking the second mantissa (e.g., weight mantissa WtM), such as described in conjunction with at least FIG. 4. For example, the multiplexer can receive the respective control signal (e.g., C[n]) from the comparator circuit 120, the corresponding second mantissa from the input circuit 104, and zero. The multiplexer can select, according to the respective control signal, the corresponding second mantissa as an output to multiply with the corresponding first mantissa via the one or more logic gates M1 (e.g., the multiplier) based on the corresponding exponent difference being less than the exponent sum threshold. The multiplexer can select, according to the respective control signal, the zero as an output to multiply with the corresponding first mantissa based on the corresponding exponent difference being greater than or equal to the exponent sum threshold. In this case, the multiplexer can mask the second mantissa to reduce computation resources.

In some implementations, the circuit 100 (e.g., the multiplier circuit 106) can include a multiplexer (e.g., MUX 122) for directly outputting zero as the output of multiplier circuit 106 (e.g., output of the multiplier or the one or more logic gates M1) based on the control signal, such as described in conjunction with at least FIG. 6. For example, the multiplexer can receive the respective control signal (e.g., C[n]) from the comparator circuit 120, the corresponding mantissa product from the multiplier, and zero. The multiplexer can select, according to the respective control signal, the corresponding mantissa product as an output from the corresponding one of the N multiplier circuits based on the corresponding exponent difference being less than the exponent sum threshold. The multiplexer can select, according to the respective control signal, the zero as an output from the corresponding one of the N multiplier circuits based on the corresponding exponent difference being greater than or equal to the exponent sum threshold. In this case, the multiplexer can directly output zero if the exponent difference is greater than or equal to the exponent sum threshold to reduce computation resources.

In some implementations, the multiplier (or the one or more logic gates M1) of the multiplier circuit 106 can receive the control signal in addition to at least the first mantissa and the second mantissa, such as described in conjunction with at least FIG. 5. For example, in cases when the comparator circuit 120 determines that the exponent difference is less than the threshold, the comparator circuit 120 can send a control signal of 1 for multiplication with the corresponding mantissa product (e.g., via the multiplier). In such cases, the multiplier can output the corresponding mantissa product as the result. In another example, in cases when the comparator circuit 120 determines that the exponent difference is greater than or equal to the threshold, the comparator circuit 120 can send a control signal of 0 for multiplication with the corresponding mantissa product (e.g., via the multiplier). In such cases, the resulting product P[n] of the multiplier can be zero. As such, each of the N multiplier circuits 106 can mask the corresponding mantissa product with zero according to the respective control signal based on the corresponding exponent difference being greater than or equal to the exponent sum threshold.

In some configurations, the circuit 100 can include multiple types (or combinations) of masking or implementations of the MUX 122, such as a combination of masking the first mantissa (e.g., InM), masking the second mantissa (e.g., WtM), masking a multiplier output (e.g., the one or more logic gates M1), and/or directly outputting zero from the multiplier circuit 106 as the product P[n], among others. For example, the circuit 100 can include N multiplier circuits 106, such as a first multiplier circuit, a second multiplier circuit, a third multiplier circuit, and a fourth multiplier circuit. The first multiplier circuit can include a MUX 122 configured to mask the first input mantissa based on the corresponding control signal. The second multiplier circuit can include a MUX 122 configured to mask the second input mantissa based on the corresponding control signal. The third multiplier circuit can include a MUX 122 configured to directly output zero as the product of the third multiplier circuit based on the corresponding control signal. The fourth multiplier circuit can include a multiplier configured to receive three inputs including the control signal, the first mantissa, and the second mantissa, where the output of the multiplier can be masked based on the control signal. Thus, the masking or implementation of the MUX 122 can be different for individual N multiplier circuits 106.

In some implementations, the circuit 100 (e.g., the summing circuit 108) can determine whether to send the corresponding exponent sum (e.g., S[n]) or one of the corresponding first exponent or the second exponent to the difference circuit 110 (e.g., the subtractor circuit) based on whether the N first exponents are the same with each other or the N second exponents are the same with each other. The determination to send the corresponding exponent sum or one of the corresponding first exponent or the second exponent to the difference circuit 110 can be described in conjunction with but not limited to at least one of FIGS. 7-9.

For example, the circuit 100 can include a similarity circuit (e.g., 704) configured to compare the N second exponents to each other and generate a second control signal based on the comparison between the N second exponents, such as described in conjunction with at least FIG. 9. In this case, each of the N multiplexers of the circuit 100 can receive the second control signal, the respective one of the N exponent sums, and the corresponding first exponent. Each of the N multiplexers can select, according to the second control signal, the respective one of the N exponent sums or the corresponding first exponent as an output to at least one of the selector circuit (e.g., 111) or the corresponding subtractor circuit (e.g., 110) to calculate the corresponding exponent difference. For instance, if the N second exponents are equal to each other, the similarity circuit 704 can generate a corresponding second control signal (e.g., C2) to the N multiplexers. Accordingly, each of the N multiplexers can select the corresponding first exponent as the output based on the second control signal. Otherwise, each of the N multiplexers can select the respective one of the N exponent sums as the output based on at least one of the N second exponents being different from another one of the N second exponents.

In another example, the circuit 100 can include a similarity circuit (e.g., 704) configured to compare the N first exponents to each other and generate a second control signal based on the comparison between the N first exponents, such as described in conjunction with at least FIG. 7. In this case, each of the N multiplexers of the circuit 100 can receive the second control signal, the respective one of the N exponent sums, and the corresponding second exponent. Each of the N multiplexers can select, according to the second control signal, the respective one of the N exponent sums or the corresponding second exponent as an output to at least one of the selector circuit (e.g., 111) or the corresponding subtractor circuit (e.g., 110) to calculate the corresponding exponent difference. For instance, if the N first exponents are equal to each other, the similarity circuit 704 can generate a corresponding second control signal (e.g., C2) to the N multiplexers. Accordingly, each of the N multiplexers can select the corresponding second exponent as the output based on the second control signal. Otherwise, each of the N multiplexers can select the respective one of the N exponent sums as the output based on at least one of the N first exponents being different from another one of the N first exponents.

In one aspect of the present disclosure, a computing-in-memory (CIM) circuit is disclosed. The CIM circuit includes an input circuit configured to receive: (i) a number (N) of first inputs, and (ii) N second inputs, wherein the first inputs consist of N first signs, N first exponents, and N first mantissas, and the second inputs consist of N second signs, N second exponents, and N second mantissas, and wherein each of the second inputs and a corresponding one of the N first inputs form one of N input pairs. The CIM circuit includes N summing circuits, each of the N adder circuits configured to combine the corresponding first exponent and the corresponding second exponent of a corresponding one of the N input pairs to generate a respective one of N exponent sums. The CIM circuit includes a selector circuit configured to select a largest one among the N exponent sums as a largest exponent sum. The CIM circuit includes N subtractor circuits, each of the N subtractor circuits configured to calculate a corresponding one of N exponent differences, each of the N exponent differences being equal to a difference between a corresponding one of the N exponent sums and the largest exponent sum. The CIM circuit includes N comparator circuits, each of the N comparator circuits configured to: (i) compare the corresponding exponent difference with an exponent sum threshold, and (ii) generate a corresponding one of N control signals based on the comparison between the corresponding exponent difference and the exponent sum threshold. The CIM circuit includes N multiplier circuits, each of the N multiplier circuits configured to selectively multiply the corresponding first mantissa by the corresponding second mantissa of the corresponding input pair based on the respective control signal, so as to generate a corresponding one of N mantissa products.

In another aspect of the present disclosure, a computing-in-memory (CIM) circuit is disclosed. The CIM circuit includes an input circuit configured to obtain a first input and a second input, wherein the first input includes a first exponent portion and a first mantissa portion, and the second input includes a second exponent portion and a second mantissa portion. The CIM circuit includes a first summing circuit configured to generate a first exponent sum by summing the first exponent portion and the second exponent portion. The CIM circuit includes a subtractor circuit configured to calculate an exponent difference by subtracting the first exponent sum from a largest exponent sum. The CIM circuit includes a comparator circuit configured to generate a control signal based on comparing the exponent difference with an exponent sum threshold. The CIM circuit includes a multiplier circuit configured to (i) receive the control signal, and (ii) multiply the first mantissa portion by the second mantissa portion, with one of the first mantissa portion or the second mantissa portion being selectively chosen as zero based on the control signal.

In yet another aspect of the present disclosure, a method for fabricating semiconductor devices is disclosed. The method includes obtaining, by a computing-in-memory (CIM) circuit, a first input and a second input, wherein the first input includes a first exponent portion and a first mantissa portion, and the second input includes a second exponent portion and a second mantissa portion. The method includes generating, by the CIM circuit, a first exponent sum by summing the first exponent portion and the second exponent portion. The method includes calculating, by the CIM circuit, an exponent difference by subtracting the first exponent sum from a largest exponent sum. The method includes generating, by the CIM circuit, a control signal based on comparing the exponent difference with an exponent sum threshold. The method includes selectively multiplying, by the CIM circuit, the first mantissa portion by the second mantissa portion based on the respective control signal, to generate a mantissa product.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., ±10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computing-in-memory (CIM) circuit, comprising:
an input circuit configured to receive: (i) a number (N) of first inputs, and (ii) N second inputs, wherein the first inputs consist of N first signs, N first exponents, and N first mantissas, and the second inputs consist of N second signs, N second exponents, and N second mantissas, and wherein each of the second inputs and a corresponding one of the N first inputs form one of N input pairs;
N summing circuits, each of the N summing circuits configured to combine the corresponding first exponent and the corresponding second exponent of a corresponding one of the N input pairs to generate a respective one of N exponent sums;
a selector circuit configured to select a largest one among the N exponent sums as a largest exponent sum;
N subtractor circuits, each of the N subtractor circuits configured to calculate a corresponding one of N exponent differences, each of the N exponent differences being equal to a difference between a corresponding one of the N exponent sums and the largest exponent sum;
N comparator circuits, each of the N comparator circuits configured to: (i) compare the corresponding exponent difference with an exponent sum threshold, and (ii) generate a corresponding one of N control signals based on the comparison between the corresponding exponent difference and the exponent sum threshold; and
N multiplier circuits, each of the N multiplier circuits configured to selectively multiply the corresponding first mantissa by the corresponding second mantissa of the corresponding input pair based on the respective control signal, so as to generate a corresponding one of N mantissa products.

2. The CIM circuit of claim 1, comprising:
N multiplexers, each of the N multiplexers configured to (i) receive the corresponding one of the N control signals from the corresponding one of the N comparator circuits, a first input, and a second input, and (ii) output one of the first input or the second input according to the respective control signal, wherein the first input is zero and the second input is one of the corresponding first mantissa, the corresponding second mantissa, or the corresponding mantissa product.

3. The CIM circuit of claim 1, wherein each of the N multiplier circuits comprises a multiplexer configured to:
receive the respective control signal, the corresponding first mantissa, and zero; and
select, according to the respective control signal, the corresponding first mantissa as an output to multiply with the corresponding second mantissa based on the corresponding exponent difference being less than the exponent sum threshold; or
select, according to the respective control signal, the zero as an output to multiply with the corresponding second mantissa based on the corresponding exponent difference being greater than or equal to the exponent sum threshold.

4. The CIM circuit of claim 1, wherein each of the N multiplier circuits comprises a multiplexer configured to:
receive the respective control signal, the corresponding second mantissa, and zero; and
select, according to the respective control signal, the corresponding second mantissa as an output to multiply with the corresponding first mantissa based on the corresponding exponent difference being less than the exponent sum threshold; or
select, according to the respective control signal, the zero as an output to multiply with the corresponding first mantissa based on the corresponding exponent difference being greater than or equal to the exponent sum threshold.

5. The CIM circuit of claim 1, wherein each of the N multiplier circuits comprises a multiplexer configured to:
receive the respective control signal, the corresponding mantissa product, and zero; and
select, according to the respective control signal, the corresponding mantissa product as an output from the corresponding one of the N multiplier circuits based on the corresponding exponent difference being less than the exponent sum threshold; or
select, according to the respective control signal, the zero as an output from the corresponding one of the N multiplier circuits based on the corresponding exponent difference being greater than or equal to the exponent sum threshold.

6. The CIM circuit of claim 1, wherein each of the N multiplier circuits is configured to mask the corresponding mantissa product with zero according to the respective control signal based on the corresponding exponent difference being greater than or equal to the exponent sum threshold.

7. The CIM circuit of claim 1, comprising:
a similarity circuit configured to (i) compare the N second exponents to each other, and (ii) generate a second control signal based on the comparison between the N second exponents; and
N multiplexers, each of the N multiplexers configured to (i) receive the second control signal, the respective one of the N exponent sums, and the corresponding first exponent, and (ii) select, according to the second control signal, the respective one of the N exponent sums or the corresponding first exponent as an output to at least one of the selector circuit or the corresponding subtractor circuit to calculate the corresponding exponent difference.

8. The CIM circuit of claim 7, wherein each of the N multiplexers is configured to:
select the corresponding first exponent as the output based on the N second exponents being equal to each other; or
select the respective one of the N exponent sums as the output based on at least one of the N second exponents being different from another one of the N second exponents.

9. The CIM circuit of claim 1, comprising:
a similarity circuit configured to (i) compare the N first exponents to each other, and (ii) generate a second control signal based on the comparison between the N first exponents; and
N multiplexers, each of the N multiplexers configured to (i) receive the second control signal, the respective one of the N exponent sums, and the corresponding second exponent, and (ii) select, according to the second control signal, the respective one of the N exponent sums or the corresponding second exponent as an output to at least one of the selector circuit or the corresponding subtractor circuit to calculate the corresponding exponent difference.

10. The CIM circuit of claim 9, wherein each of the N multiplexers is configured to:
select the corresponding second exponent as the output based on the N first exponents being equal to each other; or
select the respective one of the N exponent sums as the output based on at least one of the N first exponents being different from another one of the N first exponents.

11. A computing-in-memory (CIM) circuit, comprising:
an input circuit configured to obtain a first input and a second input, wherein the first input includes a first exponent portion and a first mantissa portion, and the second input includes a second exponent portion and a second mantissa portion;
a first summing circuit configured to generate a first exponent sum by summing the first exponent portion and the second exponent portion;
a subtractor circuit configured to calculate an exponent difference by subtracting the first exponent sum from a largest exponent sum;
a comparator circuit configured to generate a control signal based on comparing the exponent difference with an exponent sum threshold; and
a multiplier circuit configured to (i) receive the control signal, and (ii) multiply the first mantissa portion by the second mantissa portion, with one of the first mantissa portion or the second mantissa portion being selectively chosen as zero based on the control signal.

12. The CIM circuit of claim 11, wherein the input circuit is configured to obtain a third input and a fourth input, wherein the third input includes a third exponent portion and a third mantissa portion, and the fourth input includes a fourth exponent portion and a fourth mantissa portion,
the CIM circuit further comprises:
a second summing circuit configured to generate a second exponent sum by summing the third exponent portion and the fourth exponent portion; and
a selector circuit configured to select a largest one among the first exponent sum and the second exponent sum as the largest exponent sum.

13. The CIM circuit of claim 11, comprising:
a multiplexer configured to (i) receive the control signal from the comparator circuit, a third input, and a fourth input, and (ii) output one of the third input or the fourth input according to the control signal, wherein the third input is the zero and the fourth input is one of the first mantissa portion, the second mantissa portion, or a product from multiplying the first mantissa portion by the second mantissa portion.

14. The CIM circuit of claim 11, wherein the multiplier circuit comprises a multiplexer configured to:
receive the control signal, the first mantissa portion, and the zero; and
select, according to the control signal, the first mantissa portion as an output to multiply with the second mantissa portion based on the exponent difference being less than the exponent sum threshold; or
select, according to the control signal, the zero as an output to multiply with the second mantissa portion based on the exponent difference being greater than or equal to the exponent sum threshold.

15. The CIM circuit of claim 11, wherein the multiplier circuit comprises a multiplexer configured to:
receive the control signal, the second mantissa portion, and the zero; and
select, according to the control signal, the second mantissa portion as an output to multiply with the first mantissa portion based on the exponent difference being less than the exponent sum threshold; or
select, according to the control signal, the zero as an output to multiply with the first mantissa portion based on the exponent difference being greater than or equal to the exponent sum threshold.

16. The CIM circuit of claim 11, wherein the multiplier circuit comprises a multiplexer configured to:
receive the control signal, a mantissa product from multiplying the first mantissa portion by the second mantissa portion, and the zero; and
select, according to the control signal, the mantissa product as an output from the multiplier circuit based on the exponent difference being less than the exponent sum threshold; or
select, according to the control signal, the zero as an output from the multiplier circuit based on the exponent difference being greater than or equal to the exponent sum threshold.

17. The CIM circuit of claim 11, wherein the multiplier circuit is configured to mask a mantissa product, from multiplying the first mantissa portion by the second mantissa portion, with zero according to the control signal based on the exponent difference being greater than or equal to the exponent sum threshold.

18. A method, comprising:
obtaining, by a computing-in-memory (CIM) circuit, a first input and a second input, wherein the first input includes a first exponent portion and a first mantissa portion, and the second input includes a second exponent portion and a second mantissa portion;
generating, by the CIM circuit, a first exponent sum by summing the first exponent portion and the second exponent portion;
calculating, by the CIM circuit, an exponent difference by subtracting the first exponent sum from a largest exponent sum;
generating, by the CIM circuit, a control signal based on comparing the exponent difference with an exponent sum threshold; and
selectively multiplying, by the CIM circuit, the first mantissa portion by the second mantissa portion based on the respective control signal, to generate a mantissa product.

19. The method of claim 18, further comprising:
receiving, by the CIM circuit, a third input and a fourth input, wherein the third input includes a third exponent portion and a third mantissa portion, and the fourth input includes a fourth exponent portion and a fourth mantissa portion;
generating, by the CIM circuit, a second exponent sum by summing the third exponent portion and the fourth exponent portion; and
selecting, by the CIM circuit, a largest one among the first exponent sum and the second exponent sum as the largest exponent sum.

20. The method of claim 18, comprising:
outputting, by the CIM circuit according to the control signal, one of the first mantissa portion, the second mantissa portion, or the mantissa product based on the exponent difference being less than the exponent sum threshold; or
outputting, by the CIM circuit according to the control signal, zero based on the exponent difference being greater than or equal to the exponent sum threshold.
